(19) United States
(12) Patent Application Publication
(10) Pub. No.: US 2025/0250378 A1
(43) Pub. Date: Aug. 7, 2025

(54) CYANONORBORNENE POLYMERS FOR OIL RESISTANT PHOTOIMAGEABLE COMPOSITIONS

(71) Applicant: PROMERUS, LLC, AKRON, OH (US)

(72) Inventors: PRAMOD KANDANARACHCHI, AKRON, OH (US); LARRY F. RHODES, AKRON, OH (US)

(73) Assignee: PROMERUS, LLC, AKRON, OH (US)

(21) Appl. No.: 19/046,659

(22) Filed: Feb. 6, 2025

Related U.S. Application Data
(60) Provisional application No. 63/550,381, filed on Feb. 6, 2024.

(51) Int. Cl. C08F 232/08; C09D 145/00

(52) U.S. Cl. CPC C08F 232/08; C09D 145/00; C08F 2800/10; C08F 2810/20

(57) ABSTRACT

Embodiments encompassing a series of polymers containing cyano substituted norbornene monomers and maleic anhydride and/or maleimide monomers are disclosed. The polymers exhibit unusual oil resistant properties and compositions derived therefrom are photopatternable, thus having utility in a variety of optoelectronic material applications, among various other uses. More specifically, embodiments encompassing compositions containing a variety of co- and ter-polymers of cyano substituted norbornene monomers, maleic anhydride and maleimide monomers, a photoactive compound and a suitable epoxy crosslinking agents are disclosed. The compositions exhibit excellent photopatternability, high transparency, high heat resistance and most importantly oil resistant properties, thus finding applications in fabricating a variety of automotive parts.

### CROSS REFERENCE TO RELATED APPLICATIONS

This application claims the benefit of U.S. Provisional Application No. 63/550,381, filed Feb. 6, 2024, which is incorporated herein by reference in its entirety.

### BACKGROUND OF THE INVENTION

### Field of the Invention

The present invention relates to polymers and compositions derived therefrom containing a series of cyano substituted polycycloolefinic monomers, maleic anhydride and maleimide monomers, which exhibit unusual oil resistant properties and are therefore useful in a variety of applications where such oil resistant properties are warranted such as for example automotive industry. More specifically, the present invention relates to a series of copolymers and terpolymers containing a variety of cyano substituted norbornene-type cycloolefinic monomers, maleimide monomers and maleic anhydride and the compositions derived therefrom. The compositions can be formed into solid objects such as films which exhibit high transparency, heat resistance, high rigidity, biocompatibility, low density, good electrical insulation properties, good oil resistance, among other properties, and therefore, are useful in a variety of automotive and electronic material applications, among various other uses.

### Description of the Art

Cycloolefinic polymers (COPs) are generally amorphous transparent materials offering a wide range of applications. In particular, COPs find applications in the fabrication of a number of medical devices, including for example diagnostic components, drug delivery devices, microfluidic devices, microelectromechanical (MEM) devices, among others. COPs are also used in a variety of packaging applications as well as in optical applications, including lenses, light guides and sensors. However, many of the currently available COPs are not resistant to fats, oils and hydrocarbons.

Accordingly, there is a need to develop new COPs which are oil resistant and therefore can be used in applications where oil resistant properties are warranted.

Thus, it is an object of this invention to provide a new oil resistant COP having utility in a number of oil resistant applications.

### SUMMARY OF THE INVENTION

In accordance with the practice of this invention there is now provided a polymer comprising at least one monomeric repeat unit derived from a monomer of formula (I) as defined herein which contains a cyano functional group and which exhibits unusual oil resistant properties, and are therefore useful in a variety of applications where such oil resistant properties are warranted such as for example automotive industry. In a further aspect of this invention there is also provided a composition comprising aforementioned polymer which is photodefinable and can be used in a variety of opto-electronic applications. In particular, the compositions of this invention are photosensitive, for example, the films made from the composition of this invention can be developed to form patterned layers (or films) after image-wise exposure to actinic radiation, where such pattern is reflective of the image through which the layer (or film) was exposed. In this manner, structures can be provided that are, or are to become, a part of a microelectronic and/or optoelectronic devices. The incorporation of cyano functional group (nitrile group) into monomer repeat units of formula (IA) as described herein enhances hydrophilicity of the resulting polymers, among other enhancements in properties, thereby developability in such media as aqueous based tetramethyl ammonium hydroxide (TMAH) of the patterned films formed therefrom.

### BRIEF DESCRIPTION OF THE FIGURES

Embodiments in accordance with the present invention are described below with reference to the following accompanying figures and/or images. Where drawings are provided, it will be drawings which are simplified portions of a device provided for illustrative purposes only.

FIG. 1 shows UV/vis spectra of a polymer embodiment of this invention which is compared with a few of the polymers known in the art.

FIG. 2A shows optical micrograph of a positive tone lithographic images of trenches of 2 μm obtained from a photosensitive composition embodiment of this invention; and FIG. 2B shows optical micrograph of a positive tone lithographic images of 25, 50 and 75 μm square pillars obtained from a photosensitive composition embodiment of this invention.

FIG. 3 shows thermal properties of a composition embodiment of this invention which is compared with a composition known in the art.

### DETAILED DESCRIPTION OF THE INVENTION

The terms as used herein have the following meanings:

As used herein, the articles “a,” “an,” and “the” include plural referents unless otherwise expressly and unequivocally limited to one referent.

Since all numbers, values and/or expressions referring to quantities of ingredients, reaction conditions, etc., used herein and in the claims appended hereto, are subject to the various uncertainties of measurement encountered in obtaining such values, unless otherwise indicated, all are to be understood as modified in all instances by the term “about.”

Where a numerical range is disclosed herein such range is continuous, inclusive of both the minimum and maximum values of the range as well as every value between such minimum and maximum values. Still further, where a range refers to integers, every integer between the minimum and maximum values of such range is included. In addition, where multiple ranges are provided to describe a feature or characteristic, such ranges can be combined. That is to say that, unless otherwise indicated, all ranges disclosed herein are to be understood to encompass any and all sub-ranges subsumed therein. For example, a stated range of from “1 to 10” should be considered to include any and all sub-ranges between the minimum value of 1 and the maximum value of 10. Exemplary sub-ranges of the range 1 to 10 include, but are not limited to, 1 to 6.1, 3.5 to 7.8, and 5.5 to 10, etc.

As used herein, the symbol “ [symbol] ” denotes a position at which the bonding takes place with another repeat unit or another atom or molecule or group or moiety as appropriate with the structure of the group as shown.

As used herein, “hydrocarbyl” refers to a radical of a group that contains carbon and hydrogen atoms, non-limiting examples being alkyl, cycloalkyl, aryl, aralkyl, alkaryl, and alkenyl. The term “halohydrocarbyl” refers to a hydrocarbyl group where at least one hydrogen has been replaced by a halogen. The term perhalocarbyl refers to a hydrocarbyl group where all hydrogens have been replaced by a halogen.

As used herein, the expression “alkyl” includes methyl and ethyl groups, and straight-chained or branched propyl, butyl, pentyl and hexyl groups, and the like including up to specified carbon atoms. Particular alkyl groups are methyl, ethyl, n-propyl, isopropyl and tert-butyl. Derived expressions such as “alkoxy”, “thioalkyl” “alkoxy (C₁-C₄)alkyl”, “hydroxyalkyl”, “alkylcarbonyl”, “alkoxycarbonyl(C₁-C₄)alkyl”, “alkoxycarbonyl”, “diphenylalkyl”, “phenylalkyl”, “phenylcarboxyalkyl” and “phenoxyalkyl” are to be construed accordingly.

As used herein, the expression “cycloalkyl” includes all of the known cyclic groups. Representative examples of “cycloalkyl” includes without any limitation cyclopropyl, cyclobutyl, cyclopentyl, cyclohexyl, cycloheptyl, cyclooctyl, and the like. Derived expressions such as “cycloalkoxy”, “cycloalkylalkyl”, “cycloalkylaryl”, “cycloalkylcarbonyl” are to be construed accordingly.

As used herein, the expression “(C₆-C₁₀)aryl” means substituted or unsubstituted phenyl or naphthyl. Specific examples of substituted phenyl or naphthyl include o-, p-, m-tolyl, 1,2-, 1,3-, 1,4-xylyl, 1-methylnaphthyl, 2-methylnaphthyl, etc. “Substituted phenyl” or “substituted naphthyl” also include any of the possible substituents as further defined herein or one known in the art.

As used herein, the expression “(C₆-C₁₀)aryl(C₁-C₄)alkyl” means that the (C₆-C₁₀)aryl as defined herein is further attached to (C₁-C₄)alkyl as defined herein. Representative examples include benzyl, phenylethyl, 2-phenylpropyl, 1-naphthylmethyl, 2-naphthylmethyl and the like.

As used herein “heteroaryl” means a group or part of a group which is an aromatic monocyclic or bicyclic moiety of 5 to 10 ring atoms in which one or more, for example, one, two, or three, of the ring atom(s) is (are) selected from nitrogen, oxygen or sulfur, the remaining ring atoms being carbon. Representative heteroaryl rings include, but are not limited to, pyrrolyl, furanyl, thienyl, oxazolyl, isoxazolyl, thiazolyl, imidazolyl, triazolyl, tetrazolyl, pyridinyl, pyrimidinyl, pyrazinyl, pyridazinyl, indolyl, benzofuranyl, benzothiophenyl, thiophenyl, benzimidazolyl, quinolinyl, isoquinolinyl, quinazolinyl, quinoxalinyl, pyrazolyl, and the like.

“Halogen” or “halo” means chloro, fluoro, bromo, and iodo.

In a broad sense, the term “substituted” is contemplated to include all permissible substituents of organic compounds. In a few of the specific embodiments as disclosed herein, the term “substituted” means substituted with one or more substituents independently selected from the group consisting of alkyl, alkenyl, perfluoro- or partially fluorinated alkyl, phenyl, hydroxy, —CO₂H, an ester, an amide, alkoxy, thioalkyl and perfluoroalkoxy. However, any of the other suitable substituents known to one skilled in the art can also be used in these embodiments.

It should be noted that any atom with unsatisfied valences in the text, schemes, examples and tables herein is assumed to have the appropriate number of hydrogen atom(s) to satisfy such valences.

By the term “derived” is meant that the polymeric repeating units are polymerized (formed) from, e.g., polycyclic norbornene-type monomers, in accordance with formula (I) or (III) and maleic monomers of formula (II), wherein the resulting polymers are formed by 2,3 enchainment of norbornene-type monomers with maleic anhydride or maleimide monomers in an alternating fashion as shown below:

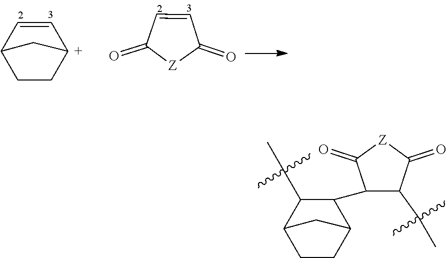

Where Z is O or NR₈, where R₈ is as defined herein.

It should be understood that depending upon the monomeric compositions in a given polymer the repeat units may not always be alternating. That is to say, for example, in a polymer containing other than 50:50 molar ratios of combined norbornene-type monomers with combined molar amounts of maleic anhydride and maleimide monomers, the repeat units are not always alternating but with random blocks of monomers with the higher molar content. It is also possible that certain maleimide monomers may not alternate with norbornene monomers and may form random blocks. Accordingly, all such combinations are part of this invention.

The term “photodefinable” refers to the characteristic of a material or composition of materials, such as a polymer composition in accordance with embodiments of the present invention, to be formed into, in and of itself, a patterned layer or a structure. In alternate language, a “photodefinable layer” does not require the use of another material layer formed thereover, for example a photoresist layer, to form the aforementioned patterned layer or structure. It will be further understood that a polymer composition having such a characteristic be employed in a pattern forming scheme to form a patterned film/layer or structure. It will be noted that such a scheme incorporates an “imagewise exposure” of the photodefinable material or layer. Such imagewise exposure being taken to mean an exposure to actinic radiation of selected portions of the layer, where non-selected portions are protected from such exposure to actinic radiation.

The phrase “a material that photonically forms a catalyst” refers to a material that, when exposed to “actinic radiation” will break down, decompose, or in some other way alter its molecular composition to form a compound capable of initiating a crosslinking reaction in the polymer, where the term “actinic radiation” is meant to include any type of radiation capable of causing the aforementioned change in molecular composition. For example, any wavelength of ultraviolet or visible radiation regardless of the source of such radiation or radiation from an appropriate X-ray and electron beam source. Non-limiting examples of suitable materials that “photonically form catalyst” include photoacid generators and photobase generators such as are discussed in detail below. It should also be noted that generally “a material that photonically forms a catalyst” will also form a catalyst if heated to an appropriate temperature. Such exposures are sometimes desirable after developing a positive tone image and to fix the images post developing by blanket exposure to a suitable radiation.

The term “cure” (or “curing”) as used in connection with a composition, e.g., “a cured composition,” shall mean that at least a portion of the crosslinkable components which are encompassed by the composition are at least partially crosslinked. In some embodiments of the present invention, the crosslinking is sufficient to render the polymer film insoluble in the developer and in some other embodiments the polymer film is insoluble in commonly used solvents. One skilled in the art will understand that the presence and degree of crosslinking (crosslink density) can be determined by a variety of methods, such as dynamic mechanical thermal analysis (DMTA). This method determines the glass transition temperature and crosslink density of free films of coatings or polymers. These physical properties of a cured material are related to the structure of the crosslinked network. Higher crosslink density values indicate a higher degree of crosslinking in the coating or film.

Embodiments in accordance with the present invention encompass polymers having at least one repeating unit derived from a norbornene-type monomer of formula (I) as defined herein, at least one repeating unit derived from a maleic anhydride-type monomer of formula (II) as defined herein. It should be understood that various other types of monomers can also be used in addition to monomers of formulae (I) and (II) to form the polymers employed in this invention especially various other “norbornene-type” monomers of formula (III) as further described herein. Such polymers can be prepared by any of the methods known in the art. Generally, such polymers are prepared by free radical polymerization methods. See for example, U.S. Pat. No. 8,715,900, which discloses ring-opened maleic anhydride polymers with alcohols (ROMA) and copolymerized with a variety of norbornene monomers.

Accordingly, in one aspect of this invention there is provided a polymer comprising one or more distinct first repeating unit represented by formula (IA), each of said first repeating unit is derived from a monomer of formula (I):

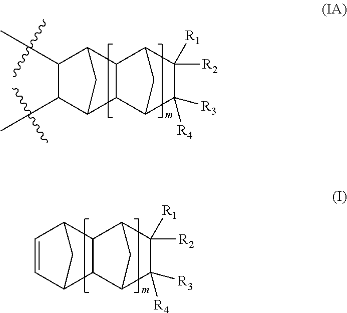

wherein:
[symbol] represents a position at which the bonding takes place with another repeat unit;
m is an integer 0, 1 or 2;
at least one of R₁, R₂, R₃ and R₄ is —CN or —R₅CN, where R₅ is selected from the group consisting of (C₁-C₁₀)alkylene, (C₃-C₈) cycloalkylene, (C₁-C₁₀)alkylene (C₃-C₈) cycloalkylene, (C₁-C₁₀)alkylene (C₃-C₈) cycloalkylene (C₁-C₁₀)alkylene, (C₁-C₁₀)alkylene (C₆-C₁₀)arylene and (C₁-C₁₀)alkylene (C₆-C₁₀)arylene (C₁-C₁₀)alkylene;
the remaining R₁, R₂, R₃ and R₄ are the same or different and independently of each other selected from the group consisting of hydrogen, methyl, ethyl, linear or branched (C₁-C₁₀)alkyl, (C₃-C₈) cycloalkyl, (C₁-C₁₀)alkyl(C₃-C₈) cycloalkyl and (C₁-C₁₀)alkyl(C₆-C₁₀)aryl;
b) one or more distinct second repeating unit represented by formula (IIA), each of said second repeating unit is derived from a monomer of formula (II):

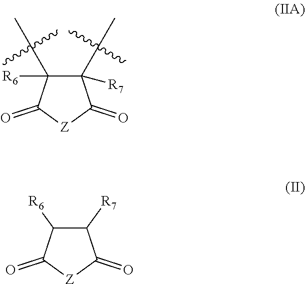

wherein:
[symbol] represents a position at which the bonding takes place with another repeat unit;
Z is O or NR₈, where R₈ is selected from the group consisting of hydrogen, (C₁-C₁₀)alkyl, (C₃-C₈) cycloalkyl, (C₁-C₁₀)alkylene (C₃-C₈) cycloalkyl, (C₁-C₁₀)alkylene (C₃-C₈) cycloalkylene (C₁-C₁₀)alkyl, (C₆-C₁₀)aryl, (C₁-C₁₀)alkylene (C₆-C₁₀)aryl and (C₁-C₁₀)alkylene (C₆-C₁₀)arylene (C₁-C₁₀)alkyl;
each of R₆ and R₇ is independently selected from the group consisting of hydrogen, methyl, ethyl, linear or branched (C₃-C₉)alkyl and fluorinated or perfluorinated (C₁-C₉)alkyl; and
with the proviso that when only one of the first repeating unit is present in the polymer wherein one of R₁, R₂, R₃ and R₄ is —CN and each of R₆ and R₇ is hydrogen, then Z is not O.

As noted, a copolymer formed from 5-cyanonorbornene (NBCN) and maleic anhydride (MA) is excluded from the aforementioned polymer embodiment. That is, copolymer, poly(NBCN-alt-MA) is known in the art. See, Anthony J. Pasquale, Ann R. Fornof, Timothy E. Long, Macromol. Chem. Phys. 2004, 205, 621-627.

Advantageously, the polymers of this invention can encompass more than one distinct monomeric repeat units wherein combined molar ratio of repeating units of formula (IA) is substantially same as the combined molar ratios of repeating units of formulae (IIA) if more than one type of monomer of formula (II) are employed. That is, as noted earlier, the molar ratios of combined monomeric units of formula (IA) are generally same as the combined molar ratios of monomeric repeat units of formulae (IIA). In other words, the monomeric repeat units of formula (IA) and monomeric units of formulae (IIA) generally alternate as already mentioned above. See for example, W. D. Beck, et al., J. Macromol. Sci. Chem., A5 (3) 491-506 (1971).

Accordingly, in some embodiments more than one distinct monomer of formula (I) can be used with more than one distinct monomer of formula (II). Thus, the polymers used to form the photosensitive or photoimageable compositions of this invention can be a terpolymer containing at least two distinct monomers of formula (I) with a monomer of formula (II); a tetrapolymer containing at least two distinct monomers of formula (I) with two distinct monomers of formula (II); a tetrapolymer containing at least three distinct monomers of formula (I) with one monomer of formula (II); and so on. All such various combinations are part of this invention. Accordingly, in one of the embodiments of this invention, the polymer of this invention is a terpolymer having repeat units derived from two distinct monomers of formula (I) and a monomer of formula (II). In another embodiment of this invention, the polymer of this invention is a tetrapolymer having repeat units derived from two distinct monomers of formula (I) and two distinct monomers of formula (II).

In another embodiment of this invention the polymer according to this invention is derived from a monomer of formula (I) in which m is 0 or 1; at least one of R₁, R₂, R₃ and R₄ is —CN; the remaining R₁, R₂, R₃ and R₄ is independently selected from the group consisting of hydrogen, methyl, ethyl, linear or branched (C₃-C₆)alkyl and phenyl(C₁-C₃)alkyl; Z is O or NR₈, where R₈ is methyl, ethyl, n-propyl, iso-propyl, n-butyl, iso-butyl, cyclopentyl, cyclohexyl, cycloheptyl, phenyl, benzyl and phenethyl; and R₆ and R₇ independently of each other selected from the group consisting of hydrogen and methyl.

As noted above, various monomers within the scope of formula (I) can be employed to form the polymers of this invention. It should further be noted that the monomers of formula (I) can exist in various stereoisomeric forms, such as for example, either as pure exo-isomer or pure endo-isomer or a mixture thereof. Accordingly, one or more such exemplary monomers that can be employed to make the polymer according to this invention, including the respective pure exo or endo forms, can be selected from the group consisting of:

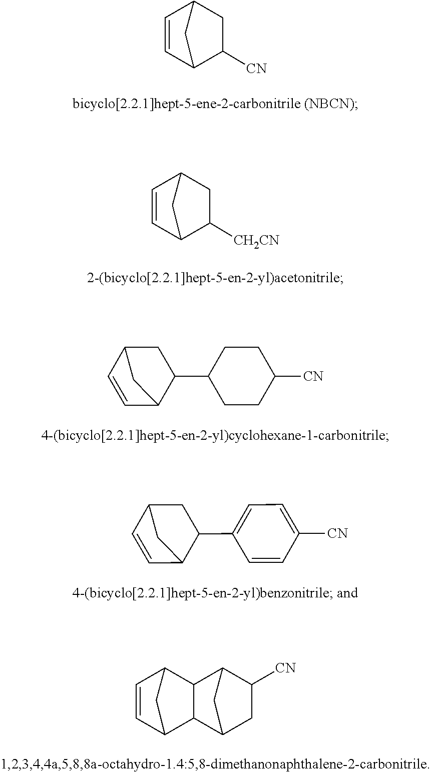

Similarly, various monomers within the scope of formula (II) can be employed to form the polymers of this invention. Accordingly, one or more such exemplary monomers that can be employed to make the polymer according to this invention can be selected from the group consisting of:

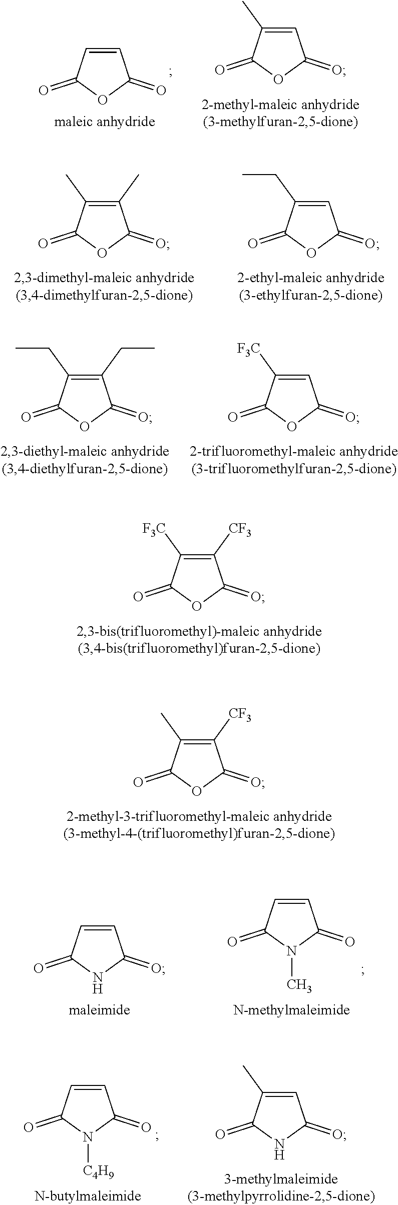

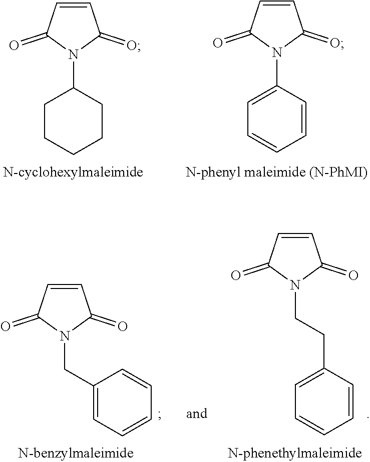 [SMILES: O=C1C=CC(=O)N1C1CCCCC1 ; O=C1C=CC(=O)N1c1ccccc1 ; O=C1C=CC(=O)N1Cc1ccccc1 ; O=C1C=CC(=O)N1CCc1ccccc1]

In another embodiment of this invention, the polymer of this invention further comprises one or more distinct third repeat unit of formula (IIIA) derived from a monomer of formula (III):

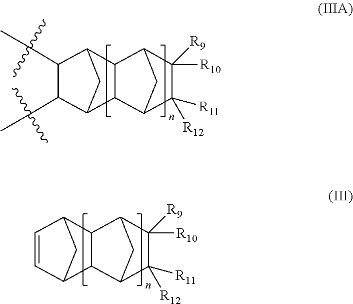

wherein:
[symbol] represents a position at which the bonding takes place with another repeat unit;
n is an integer 0, 1 or 2; and
each of R₉, R₁₀, R₁₁ and R₁₂ is independently selected from the group consisting of hydrogen, linear or branched (C₁-C₁₆)alkyl, hydroxy (C₁-C₁₂)alkyl, perfluoro (C₁-C₁₂)alkyl, (C₃-C₁₂) cycloalkyl, (C₆-C₁₂)bicycloalkyl, (C₇-C₁₄)tricycloalkyl, (C₆-C₁₀)aryl, (C₆-C₁₀)aryl(C₁-C₃)alkyl, perfluoro (C₆-C₁₀)aryl, perfluoro (C₆-C₁₀)aryl(C₁-C₃)alkyl, (C₅-C₁₀) heteroaryl, (C₅-C₁₀) heteroaryl(C₁-C₃)alkyl, hydroxy, (C₁-C₁₂)alkoxy, (C₃-C₁₂)cycloalkoxy, (C₆-C₁₂)bicycloalkoxy, (C₇-C₁₄)tricycloalkoxy, (CH₂)ₐ—(O—(CH₂)_{b})_{c}—O—(C₁-C₄)alkyl, where a, b and c are integers from 1 to 4, (C₆-C₁₀)aryloxy (C₁-C₃)alkyl, (C₅-C₁₀)heteroaryloxy (C₁-C₃)alkyl, (C₆-C₁₀)aryloxy, (C₅-C₁₀)heteroaryloxy, (C₁-C₆)acyloxy and halogen.

In another embodiment of this invention the polymer according to this invention comprises a monomer of formula (III) in which n is 0 or 1; each of R₉, R₁₀, R₁₁ and R₁₂ is independently selected from the group consisting of hydrogen, methyl, ethyl, linear or branched (C₃-C₁₂)alkyl, phenyl(C₁-C₃)alkyl, (CH₂)ₐ—(O—(CH₂)_{b})_{c}—O—(C₁-C₄)alkyl, where a is 1, b is 2 and c is 2 or 3.

Turning now to third repeating unit to form the polymer of this invention it is contemplated that any monomer within the scope of formula (III) can be used. Exemplary monomers of such type include but not limited to those selected from the group consisting of:

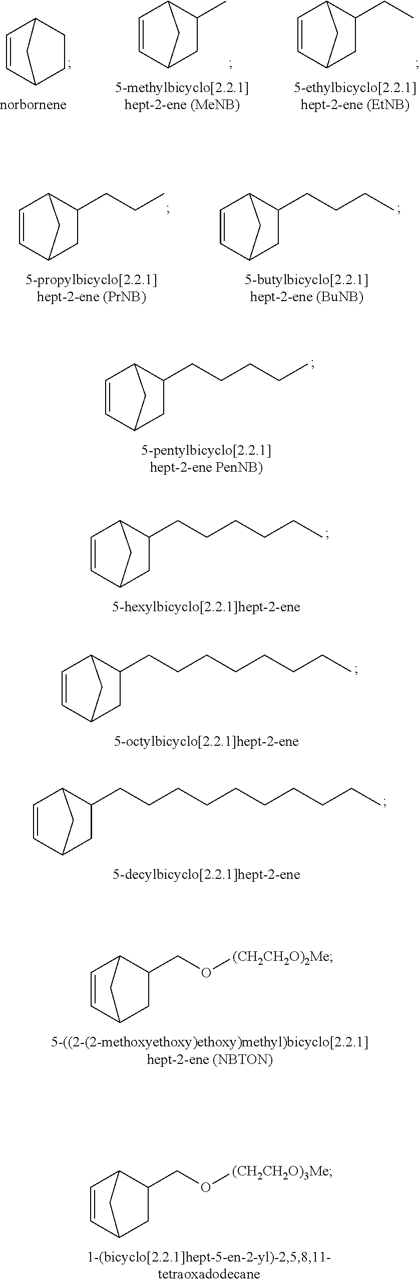

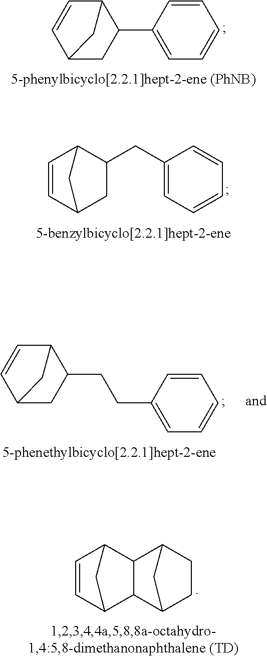

In yet another embodiment of this invention the polymer according to this invention contain one monomer repeat unit of formula (IA) and one monomer repeat unit of formula (IIA), thus forming an alternating copolymer as described hereinabove. It should however be noted that two or more distinct types of monomer repeat units of formula (IA) and two or more distinct types of monomer repeat units of formula (IIA) maybe present in the polymer of this invention. Non-limiting examples of such specific copolymers within the scope of this invention is selected from the group consisting of:
a copolymer of bicyclo[2.2.1]hept-5-ene-2-carbonitrile (NBCN) and N-phenyl maleimide (N-PhMI);
a copolymer of bicyclo[2.2.1]hept-5-ene-2-carbonitrile (NBCN) and 2-methyl-maleic anhydride;
a copolymer of bicyclo[2.2.1]hept-5-ene-2-carbonitrile (NBCN) and N-cyclohexyl maleimide; and
a copolymer of bicyclo[2.2.1]hept-5-ene-2-carbonitrile (NBCN) and N-methyl maleimide.

In yet another embodiment of this invention the polymer of this invention contains one distinct repeat unit of formula (IA), one distinct repeat unit of formula (IIA) and one distinct repeat unit of formula (IIIA) and wherein said repeat unit of formula (IA) is present at a mole percent of about 10 to 20, said repeat unit of formula (IIIA) is present at a mole percent of about 30 to 40 provided that total mole percent of repeat units of formulae (IA) and (IIIA) is about 50 and said repeat unit of formula (IIA) is present at a mole percent of about 50. In some embodiments of this invention the polymer of this invention contains one distinct repeat unit of formula (IA), one distinct repeat unit of formula (IIA) and one distinct repeat unit of formula (IIIA) and wherein said repeat unit of formula (IA) is present at a mole percent of about 5 to 10, said repeat unit of formula (IIIA) is present at a mole percent of about 40 to 45 provided that total mole percent of repeat units of formulae (IA) and (IIIA) is about 50 and said repeat unit of formula (IIA) is present at a mole percent of about 50.

Accordingly, in some embodiments the polymer according to this invention contain one monomer repeat unit of formula (IA), one monomer repeat unit of formula (IIA) and one monomer repeat unit of formula (IIIA), thus forming a terpolymer where a norbornene-type repeat units are alternating with the maleic-type repeat units as described hereinabove. Non-limiting examples of such specific terpolymers within the scope of this invention is selected from the group consisting of:
a terpolymer of bicyclo[2.2.1]hept-5-ene-2-carbonitrile (NBCN), norbornene (NB) and maleic anhydride;
a terpolymer of bicyclo[2.2.1]hept-5-ene-2-carbonitrile (NBCN),
5-butylbicyclo[2.2.1]hept-2-ene (5-butylnorbornene, BuNB) and maleic anhydride;
a terpolymer of bicyclo[2.2.1]hept-5-ene-2-carbonitrile (NBCN), 5-((2-(2-methoxyethoxy) ethoxy)methyl)bicyclo[2.2.1]hept-2-ene (NBTON) and maleic anhydride;
a terpolymer of bicyclo[2.2.1]hept-5-ene-2-carbonitrile (NBCN),
5-butylbicyclo[2.2.1]hept-2-ene (5-butylnorbornene, BuNB) and N-phenyl maleimide (N-PhMI); and
a terpolymer of bicyclo[2.2.1]hept-5-ene-2-carbonitrile (NBCN), 5-((2-(2-methoxyethoxy) ethoxy)methyl)bicyclo[2.2.1]hept-2-ene (NBTON) and N-phenyl maleimide (N-PhMI).

Useful monomers for embodiments in accordance with the present invention are described generally hereinabove. As also noted above the polymer of this invention generally encompasses equal molar amounts of repeat units derived from one or more monomers of formulae (I) and (III), if present, and repeat units derived from one or more distinct monomers of formula (II). That is to say that the total molar amounts of one or more distinct types of monomers of formula (I) and (III) and the total molar amounts of one or more distinct types of monomers of formula (II) are generally the same. However, in some embodiments the total mole ratios of repeat units of formulae (IA) and (IIIA), if present, can be higher or lower than 50 mole percent, and thus the total mole ratios of repeat units of formulae (IIA) can be different than 50 mole percent. Accordingly, in some embodiments the total mole ratios of repeat units of formulae (IA) and (IIIA), if present, is in the range of from 40 to 60 mole percent, in other embodiments the combined mole percent of repeat units of formulae (IA) and (IIIA), if present, is in the range of from 45 to 55 mole percent and in other embodiments it can be from 48 to 52 mole percent. Accordingly, in some embodiments the total mole ratios of repeat units of formulae (IIA) is in the range of from 40 to 60 mole percent, in other embodiments the combined mole percent of repeat units of formulae (IIA) is in the range of from 45 to 55 mole percent and in other embodiments it can be from 48 to 52 mole percent.

Advantageously, it has now been found that the polymers of this invention contain at least twenty mole percent of repeat units of formula (IIIA). In some other embodiments the mole percent of repeat units of formula (IIIA) is in the range of from 22 mole percent to 40 mole percent, in some other embodiments it is in the range of from 25 to 45 mole percent and in other embodiments it is in the range of from about 30 to 50 mole percent.

Generally speaking, as to various possible substituents defined for R₁ to R₁₂, it should be noted that such substituents can broadly be defined as “hydrocarbyl” group. As defined hereinabove, such definition of “hydrocarbyl” group includes any C₁ to C₃₀ alkyl, aryl, aralkyl, alkaryl, cycloalkyl, or heteroalkyl group. Representative alkyl groups include, but are not limited to, methyl, ethyl, propyl, isopropyl, butyl, isobutyl, sec-butyl, tert-butyl, pentyl, neopentyl, hexyl, heptyl, octyl, nonyl, and decyl. Representative cycloalkyl groups include, but are not limited to, adamantyl, cyclopentyl, cyclohexyl, and cyclooctyl. Representative aryl groups include, but are not limited to, phenyl, naphthyl, and anthracenyl. Representative aralkyl groups include, but are not limited to, benzyl and phenethyl. In addition, it should be noted that the hydrocarbyl groups mentioned above can be substituted, that is to say at least one of the hydrogen atoms can be replaced with, for example, alkyl, haloalkyl, perhaloalkyl, aryl, and/or cycloalkyl group(s). Representative substituted cycloalkyl groups include, among others, 4-t-butylcyclohexyl and 2-methyl-2-adamantyl. A non-limiting representative substituted aryl group is 4-t-butylphenyl.

In general, the polymers of this invention can be prepared by any one of the known procedures in the art. For instance, one or more monomers of formula (I) as described herein can be polymerized along with one or more monomers of formulae (II) and (III), if needed, to form the polymers of this invention containing the respective monomeric repeat units as represented by formulae (IA), (IIA) and (IIIA). The maleic repeat units of formula (IIA) can also be ring opened either partially or completely by subjecting to suitable reaction conditions to form ring opened repeat units of formula (IIA). Again, any of the polymerization methods can be employed to form the polymers of this invention. In general, the polymerization can be carried out either in solution using a desirable solvent or in mass, and in both instances, suitably in the presence of a catalyst or an initiator. Any of the known catalyst system which brings about the polymerization of the monomers of formula (I) with monomers of formula (II) can be used along with monomers of formula (III).

Advantageously, it has now been found that polymers of this invention can be prepared by any of the known free radical polymerization procedures. Typically in a free radical polymerization process, the monomers are polymerized in a solvent at an elevated temperature (about 50° C. to about 150° C.) in the presence of a free radical initiator. Suitable initiators include but are not limited to azo compounds and peroxides. Non-limiting examples of azo compounds include azobisisobutyronitrile (AIBN), (E)-dimethyl 2,2′-(diazene-1,2-diyl)bis(2-methylpropanoate) (AMMP), (E)-2,2′-(diazene-1,2-diyl)bis(2,4-dimethylpentanenitrile (ADMPN), 1,1′-azobis(cyclohexanecarbonitrile) (ABCN), azobisisocapronitrile and azobisisovaleronitrile. Non-limiting examples of peroxides include hydrogen peroxide, tert-butylhydroperoxide, di-(tertiary)-butyl peroxide, benzoyl peroxide, lauryl peroxide, and methyl ethyl ketone peroxide. As noted, any of the other known initiators, including other azo compounds and peroxides can also be used in this polymerization process.

Suitable polymerization solvents for the aforementioned free radical polymerization reactions include hydrocarbon, haloalkane, ketone, ester and aromatic solvents, among other suitable solvents. Exemplary hydrocarbon solvents include but are not limited to alkanes and cycloalkanes such as pentane, hexane, heptane and cyclohexane. Exemplary haloalkane solvents include but are not limited to dichloromethane, chloroform, carbon tetrachloride, ethylchloride, 1,1-dichloroethane, 1,2-dichloroethane, 1-chloropropane, 2-chloropropane, 1-chlorobutane, 2-chlorobutane, 1-chloro-2-methylpropane, 1-chloropentane, Freon™ 112 halocarbon solvent. Exemplary ketone solvents include acetone, methyl ethyl ketone (MEK), cyclopentanone and cyclohexanone. Exemplary ester solvents include methyl acetate, ethyl acetate, amyl acetate, and so on. Exemplary aromatic solvents include but are not limited to benzene, toluene, xylene, mesitylene, chlorobenzene, and o-dichlorobenzene. Other organic solvents such as diethyl ether, tetrahydrofuran, lactones and amides, including N,N-dimethylformamide (DMF), N,N-dimethylacetamide (DMAc), N-methylpyrrolidone (NMP), propyleneglycol monomethylether acetate (PGMEA), are also useful. Mixtures of one or more of the foregoing solvents can be utilized as a polymerization solvent. In some embodiments the solvents employed include ethyl acetate, amyl acetate, cyclopentanone and mixtures in any combination thereof.

The polymers as employed in this invention generally exhibit a weight average molecular weight (M_{w}) of at least about 4,000. In another embodiment, the polymer of this invention has a M_{w} of at least about 5,000. In yet another embodiment, the polymer of this invention has a M_{w} of at least about 6,000. In some other embodiments, the polymer of this invention has a M_{w} of at least about 7,000. In some other embodiments, the polymer of this invention has a M_{w} of at least about 8,000. In some other embodiments, the polymer of this invention has a M_{w} of at least about 9,000. In some other embodiments, the polymer of this invention has a M_{w} higher than 9,000 or higher than 10,000. The weight average molecular weight (M_{w}) of the polymer can be determined by any of the known techniques, such as for example, by gel permeation chromatography (GPC) equipped with suitable detector and calibration standards, such as differential refractive index detector calibrated with narrow-distribution polystyrene standards.

Thus, in accordance with the practice of this invention there is further provided a composition comprising any one or more of the polymers as described herein. The composition further comprises one or more components selected from the group consisting of: a) a photoactive compound; b) an epoxy crosslinking agent; and c) a carrier solvent. Again, any one of the polymers as described hereinabove including but not limited to the copolymers and terpolymers as described hereinabove can be used to form the composition of this invention.

As mentioned above, the polymer composition of this invention further contains a photoactive compound (PAC). Any of the PACs known to one skilled in the art which would bring about the desired results as further discussed herein can be employed in the composition of this invention. Broadly speaking, the PAC that can be employed in this invention is a photosensitive compound which when exposed to suitable radiation undergoes a chemical transformation such that the resulting product is generally more soluble in a developing solvent, such as for example, alkali solution thus facilitating the exposed regions to dissolve more readily than the unexposed regions. As noted, the composition of this invention further encompass an epoxy resin and a solvent. Further, such compositions are capable of forming films useful as self-imageable layers in the manufacture of microelectronic and optoelectronic devices. That is to say that when image-wise exposed to actinic radiation, such layers (or films) can be developed to form a patterned film, where such pattern is reflective of the image through which the film was exposed.

In this manner, structures can be provided that are, or are to become, a part of such microelectronic and/or optoelectronic devices. For example, such films may be useful as low-K dielectric layers in liquid crystal displays or in microelectronic devices. It will be noted that such examples are only a few of the many uses for such a self-imageable film, and such examples do not serve to limit the scope of such films or the polymers and polymer compositions that are used to form them.

Generally, the PACs that are suitable in this invention contain a diazo-quinone group of formula (B):

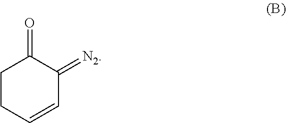

Non-limiting examples of such a photoactive compound (PAC) can include a group, such as, 1,2-naphthoquinonediazide-5-sulfonyl moiety and/or a 1,2-naphthoquinonediazide-4-sulfonyl moiety as represented by structural formulae (IVa) and (IVb), respectively:

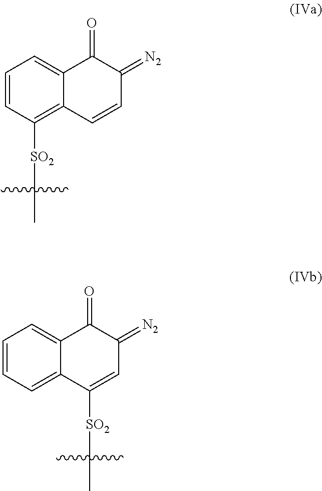

Other such photoactive moieties, among others, include sulfonyl benzoquinone diazide group represented by structural formula (IVc):

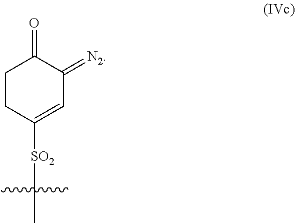

Generally, the functional groups of formulae (IVa), (IVb) and/or (IVc) are incorporated into the photosensitive composition as an esterification product of the respective sulfonyl chloride (or other reactive moiety) and a phenolic compound, such as one or more of the exemplary compounds represented below collectively as structural formulae (Va) to (Vag). Thus, any one, or any mixture of two or more of such esterification products are combined with the resin in forming the photosensitive resin compositions of the present invention. In the formulae (Va) to (Vag) below, Q may represent any of the structures (IVa), (IVb) or (IVc). Advantageously, when a portion of a film or a layer of the photosensitive composition is exposed to appropriate electromagnetic radiation, these esterification products generate a carboxylic acid which enhances the solubility of such exposed portion in an aqueous alkali solution as compared to any unexposed portions of such film. Generally, such photosensitive materials are incorporated into the composition in an amount from 1 to 50 parts by weight material to 100 parts by weight resin. Where the specific ratio of the photosensitive material to resin is a function of the dissolution rate of exposed portions as compared to unexposed portions and the amount of radiation required to achieve a desired dissolution rate differential.

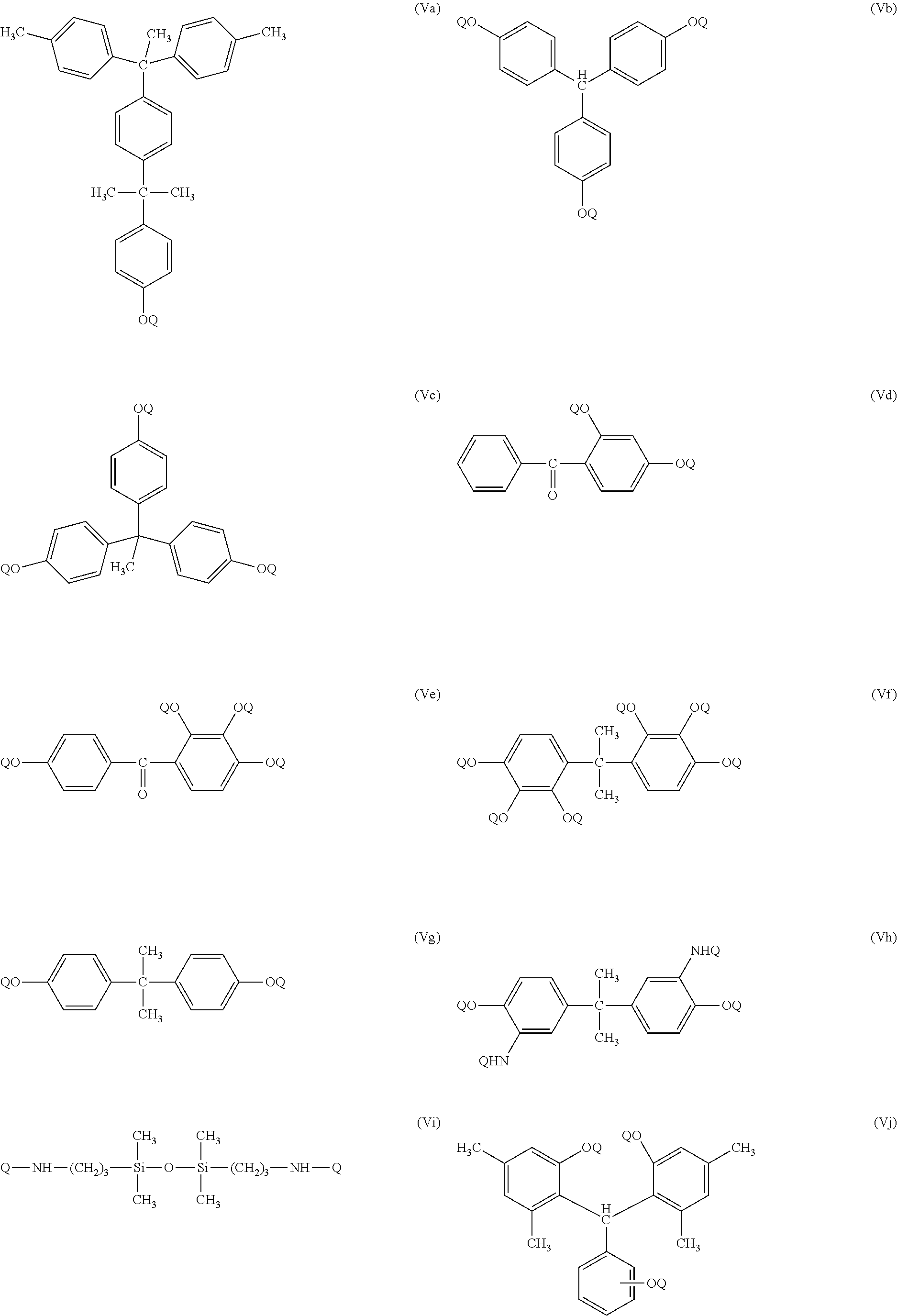

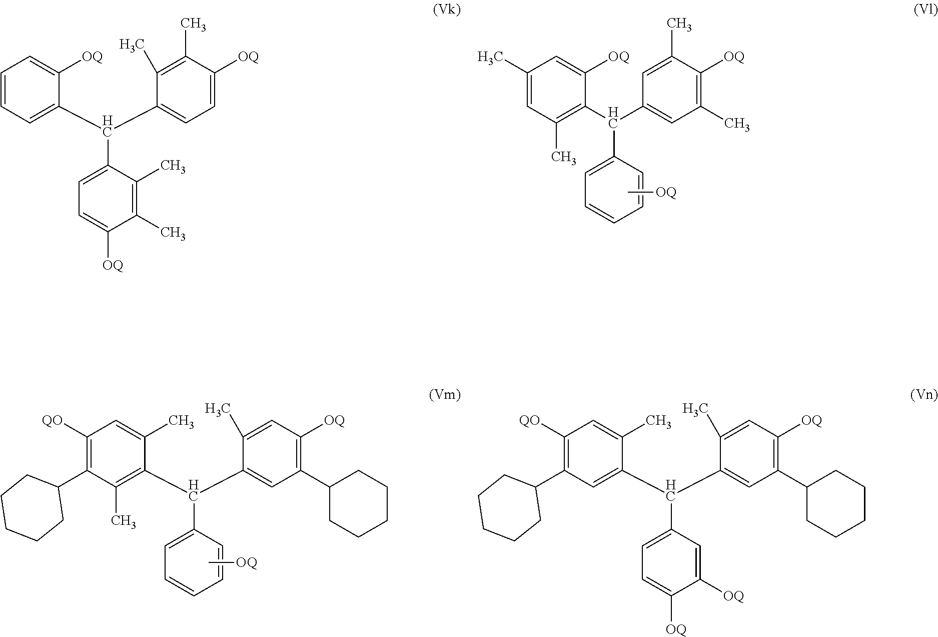

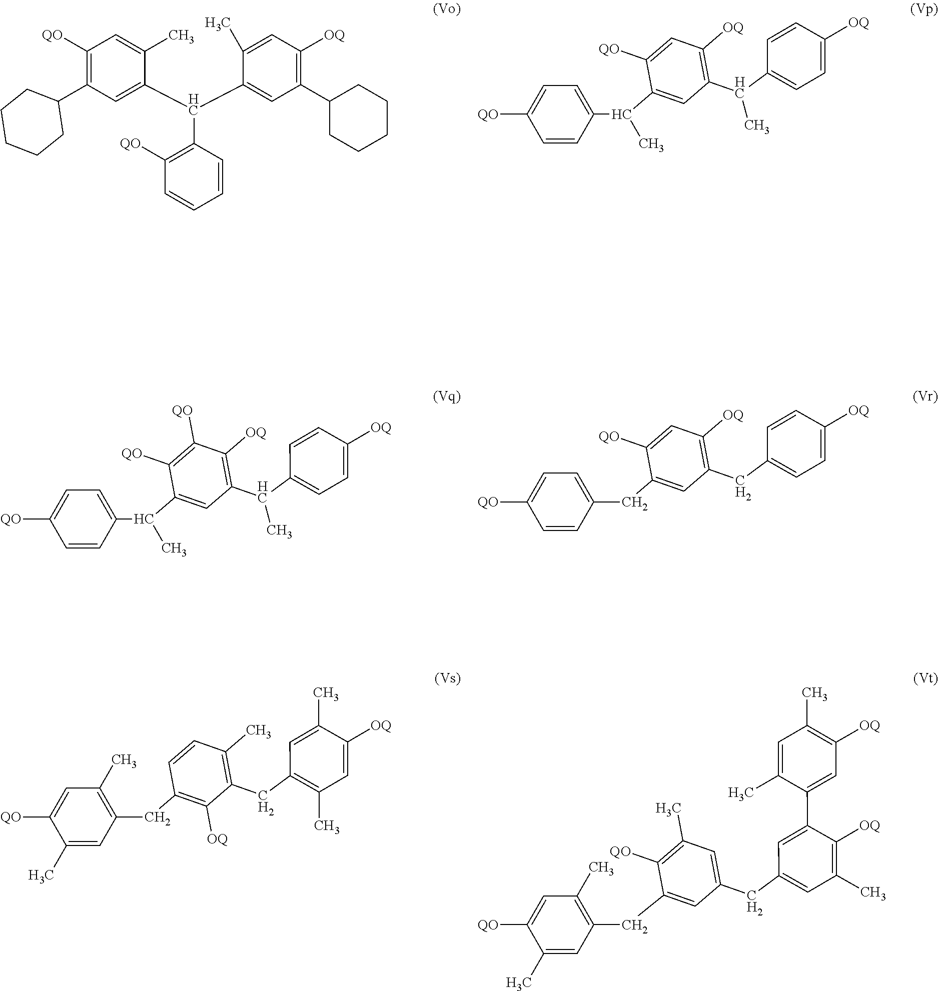

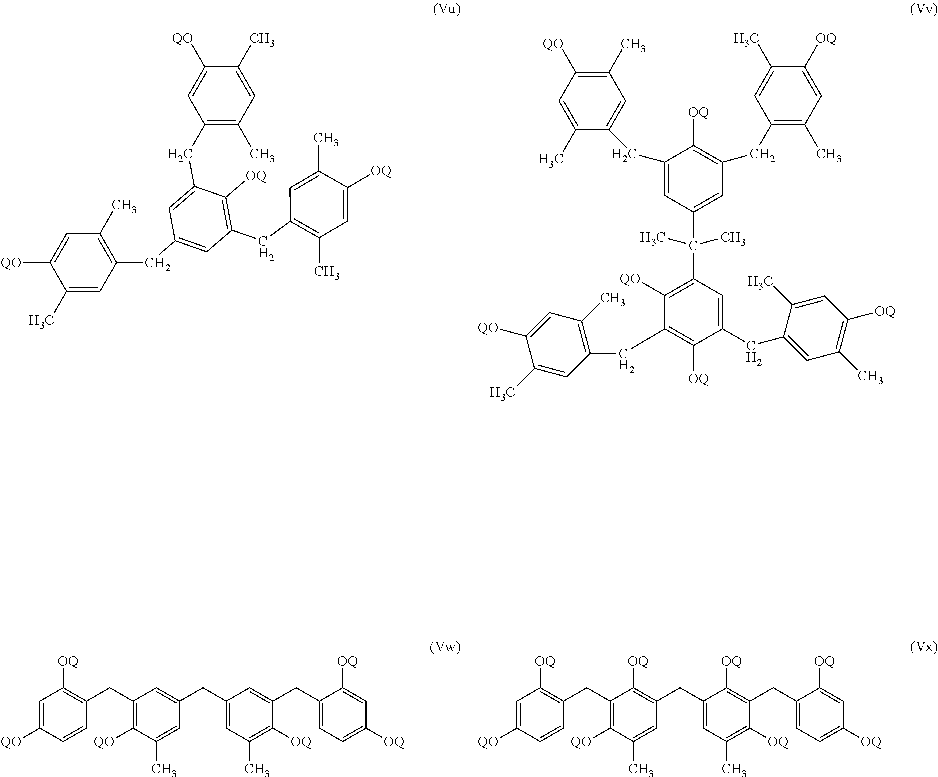

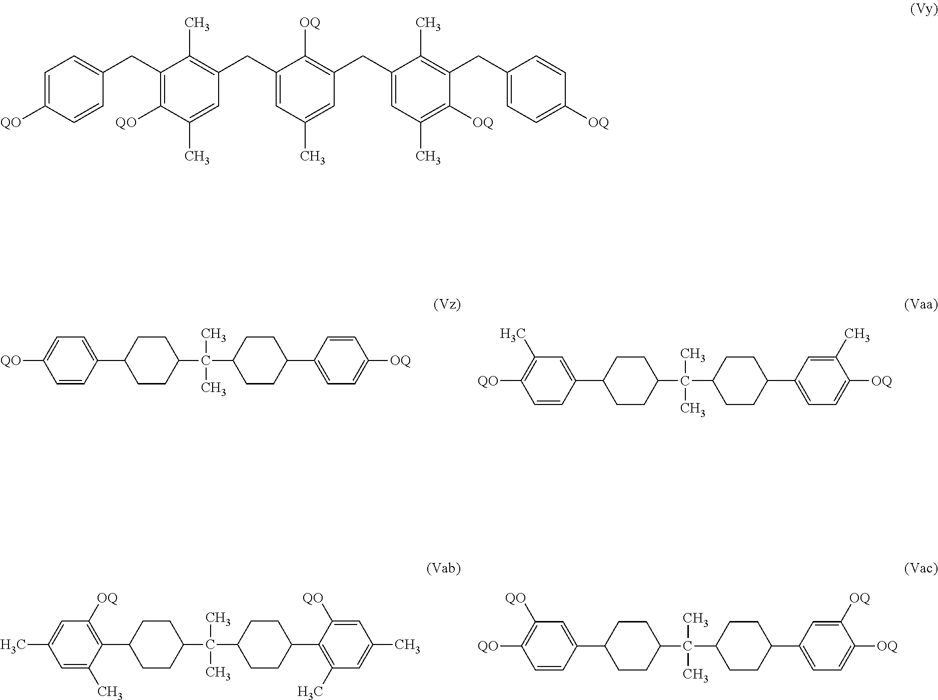

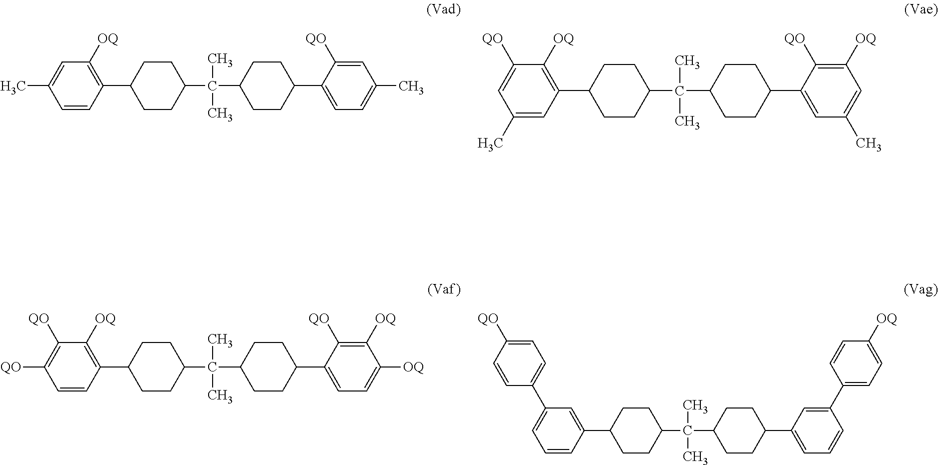

In the above listed PACs of formulae (Va) to (Vag), Q refers to any one of photoactive moieties of formulae (IVa), (IVb) or (IVc) or hydrogen, but at least one of these Q in each of these structures is (IVa), (IVb) or (IVc). Several of the PACs listed above are commercially available. For example, SCL6 of formula (Vd) (Secant Chemicals Inc., Winchendon, MA, USA), Tris-P3M6C-2-201 of formula (Vo), collectively TS-200, TS-250 and TS-300 of formula (Va), and 4NT-300 of formula (Ve) (all from Toyo Gosei Co. Ltd., Chiba, Japan). It should be noted that for PACs of the types TS-200, TS-250 and TS-300, the degree of substitution of Qs also varies based on the product used. For instance, TS-200 is substituted with 67% of Q, TS-250 is substituted with 83% of Q, and TS-300 with 100% of Q, the unsubstituted portion being hydrogen. Again, Q in each of these instances refers to one of groups (IVa), (IVb) or (IVc).

The amount of PACs incorporated into the polymer composition depends upon the type of polymer used and to the dosage level of the exposure contemplated. The amount can vary generally from about 5 to 50 parts per 100 parts by weight of the polymer and typically from about 10 to about 40 parts by weight, although other advantageous amounts of such materials are also appropriate and within the scope of the present invention.

Exemplary epoxies and other cross-linking additives, as mentioned above, include, but are not limited to, bisphenol A epoxy resin (LX-1-Daiso Chemical Co., Osaka, Japan), 2,2′-((((1-(4-(2-(4-(oxiran-2-ylmethoxy)phenyl) propan-2-yl)phenyl) ethane-1,1-diyl)bis(4,1-phenylene))bis(oxy))bis(methylene))bis(oxirane) (Techmore VG3101L-Mitsui Chemical Inc.), trimethylolpropane triglycidylether (TMPTGE-CVC Specialty Chemicals, Inc.), and 1,1,3,3,5,5-hexamethyl-1,5-bis(3-(oxiran-2-ylmethoxy) propyl)trisiloxane (DMS-E09-Gelest, Inc.), liquid epoxy resins (D.E.R.™ 732, where n=8 to 10, and D.E.R.™ 736, where n=4 to 6-both from Dow Chemical Company), bis(4-(oxiran-2-ylmethoxy)phenyl) methane (EPON™ 862, Hexion Specialty Chemicals, Inc.), triglycidyl ether of poly(oxypropylene) epoxide ether of glycerol (commercially available as Heloxy 84 or GE-36 from Momentive Specialty Chemicals Inc.), 2-((4-(tert-butyl) phenoxy)methyl) oxirane (commercially available as Heloxy 65 from Momentive Specialty Chemicals Inc.) and silicone modified epoxy compound (commercially available as BY16-115 from Toray-Dow Corning Silicone Co., Ltd.) as shown below:

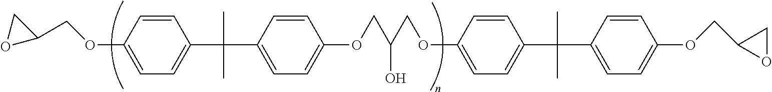

LX-01, where n is from 1 to 5;

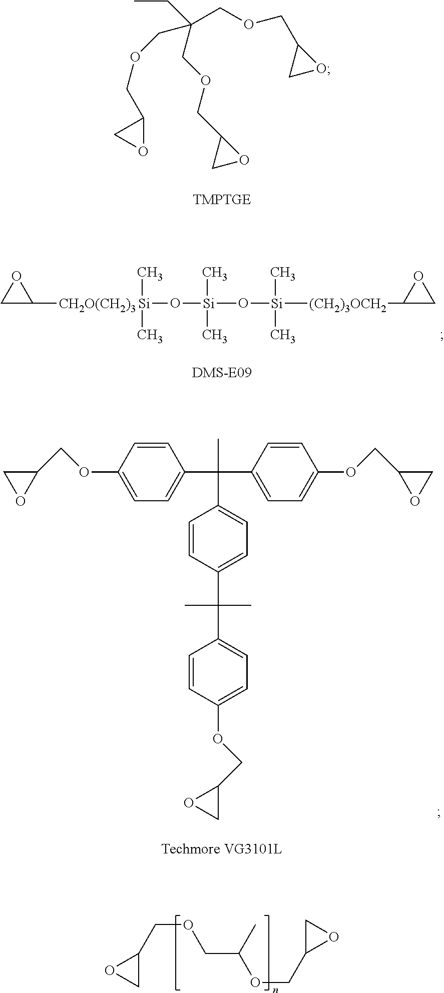

D.E.R.™ 732, where n=8 to 10 and D.E.R.™ 736, where n=4 to 6;

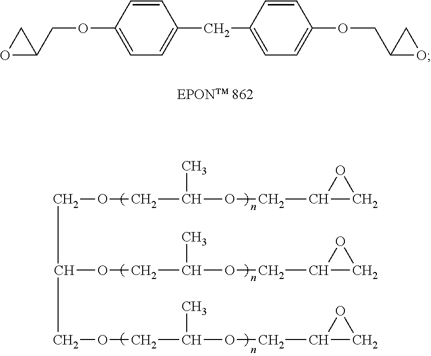

triglycidyl ether of poly(oxypropylene) epoxide ether of glycerol, where n is from 6 to 10, commercially available as Heloxy 84 or GE-36 from Momentive Specialty Chemicals Inc.;

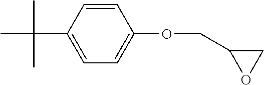

2-((4-(tert-butyl) phenoxy)methyl) oxirane, commercially available as Heloxy 65 from

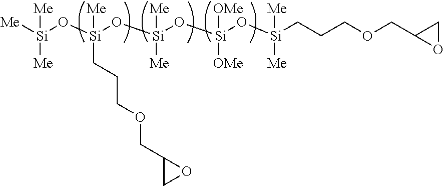

Silicone modified epoxy compound commercially available as BY16-115 from Toray-Dow Corning Silicone Co., Ltd.;

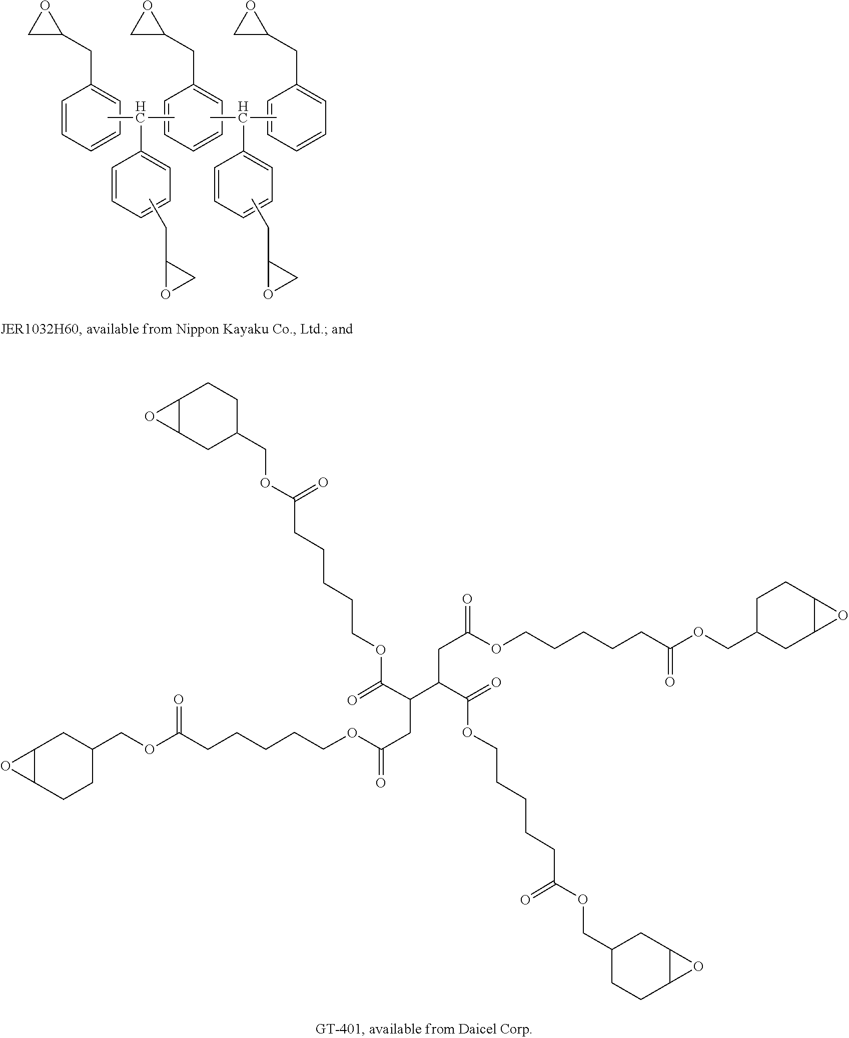

Other cross-linking agents that can be used in the compositions of this invention include the following:

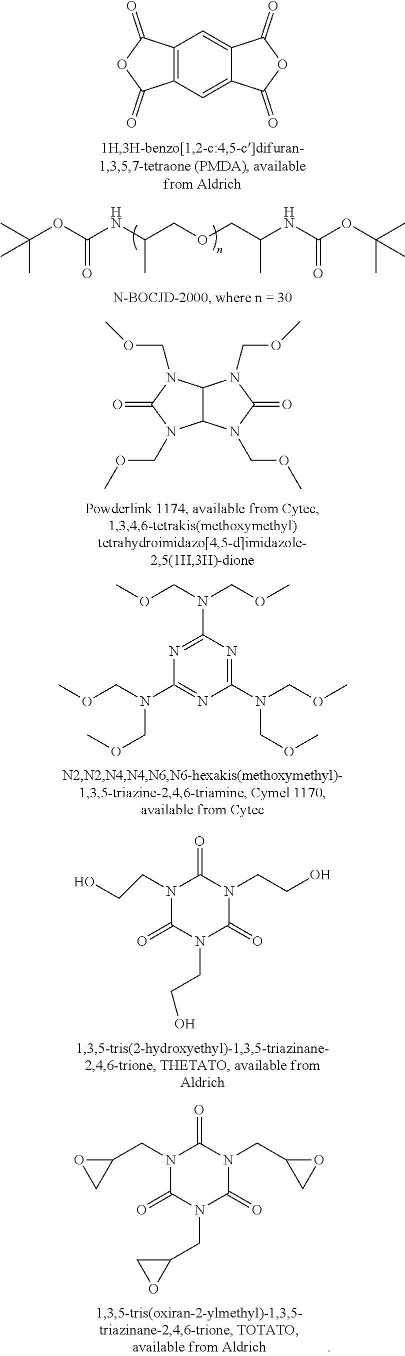

Still other exemplary epoxy resins or cross-linking additives include, among others Araldite MTO163 and Araldite CY179 (manufactured by Ciba Geigy); and EHPE-3150, Epolite GT300 and (manufactured by Daicel Chemical).

The amount of epoxy compound may also vary as noted for PACs depending upon the base polymer employed in the composition and the amount can also vary depending upon the intended result. The amount can vary generally from about 1 to 50 parts by weight per 100 parts of the polymer and typically from about 2 to about 30 parts by weight, although other advantageous amounts of such materials are also appropriate and within the scope of the present invention. In addition, one or more different types of epoxy compounds as enumerated herein can be used in the composition of this invention and the amounts of each can thus be varied as needed.

Advantageously, it has now been found that polymer composition of this invention provides several desirable properties especially when compared to several of the polymers reported in the literature for similar applications. For instance, the polymers of this invention exhibit substantially higher hydrophilic properties when compared with similar polymers available in the art, for example, Zeonex and Topas types of polymers. The higher hydrophilicity exhibited by the polymers of this invention can be measured by any of the known methods in the art such as for example by contact angle measurements of the films formed from the polymers of this invention. Typically the polymers of this invention exhibit contact angles lower than 70°, generally in the range of from about 40° to 60°. Whereas the commercially available polymers such as Zeonex and/or Topas exhibit contact angles higher than 95°. Thus the polymers of this invention are more useful in such applications where more hydrophilic polymers can be used.

Advantageously it has also been observed that the polymers of this invention exhibit essentially transparent properties similar to those exhibited by similar polymers known in the art. For instance, the polymers of this invention exhibit substantially transparent property in the UV/visible region of the spectrum, i.e., 300-800 nm wavelength range as is expected for the commercially available polymers such as Zeonex and/or Topas. That is, no substantial absorption of light is observed in the wavelength range of 300-800 nm, thus allowing transmission of 95 to 100 percent of the incident light. Thus the polymers of this invention find utility in various optical and electronic applications.

Even more advantageously the polymers of this invention exhibit unusually high level of resistance to oil. For instance, when the films formed from the polymers of this invention are exposed to different types of oils, the films formed from the polymers of this invention remained intact even after exposure to oil environment for several minutes. However, similar polymers known in the art such as for example Zeonex or Topas disintegrated into pieces even after exposure to olive oil just in five minutes. Accordingly, in some embodiments the polymers of this invention is stable to olive oil for at least 10 minutes, for at least 20 minutes, for at least 30 minutes, 60 minutes or longer.

Another advantageous property exhibited by the compositions of this invention is that they are photoimageable exhibiting good resolution. The compositions exhibit excellent dissolution rate in the developing solvent, such as for example, aqueous based alkali developer, including tetramethylammonium hydroxide (TMAH), among other known aqueous developers. This can further be tailored based on the type of the polymer employed. Generally, it has now been found that by judicious selection of the polymer, which is a terpolymer as described herein and by controlling the molar ratios of the repeat units of formulae (I) and (III) it is now possible to control the dissolution rate of the composition of this invention to the desirable range. Furthermore, the compositions of this invention retain much needed lithographic resolution, photospeed and high degree of chemical resistance, among various other desirable properties.

More advantageously and surprisingly, it has also been found that the compositions of this invention exhibit improved thermomechanical properties. For instance, the compositions of this invention exhibit very high thermal stability, i.e., higher than 200° C. Therefore, the compositions of this invention can be employed in applications where such high temperature stabilities are required as further demonstrated by specific examples that follow. In addition, the compositions of this invention also exhibit excellent mechanical properties and form high resolution images after “image-wise” exposed to suitable actinic radiation.

In addition, various other additives/components can be added to the composition of this invention, which is used for the formation of the photoimageable layer such that its mechanical and other properties can be tailored as desired. Also, other additives can be used to alter the processability, which include increase the stability of the polymer to thermal and/or light radiation. In this regard, the additives can include, but are not limited to, crosslinkers, photosensitizers, antioxidants, adhesion promoters, cure catalysts, surface leveling agents, surfactants, thermal acid and/or thermal base generator, such as CXC 1761 from King Industries, Inc., photo acid and/or photo base generator, catalyst scavengers, stabilizers, reactive diluents, and the like. Any of these additives can be used as a mixture in any combination thereof.

Advantageously it has also been observed that a blend of polymers can be used in the composition of this invention. That is to say that a copolymer of this invention containing a cyanosubstituted norbornene and maleic units as described herein can be blended with other copolymers which do not have the cyanosubstituted norbornene units. It has been surprisingly found that a homogeneous blend of copolymers (or the terpolymers) of this invention with a variety of copolymers of norbornene type monomers with maleic units known in the art can be formed which show no phase separation. The compositions formed from such blends exhibit excellent dissolution properties. Accordingly, in some embodiments there is provided a composition containing a blend of copolymers (or terpolymers) formed according to this invention with a variety of copolymers of norbornene-type monomers and maleic monomers known in the art. Any amounts of copolymers of this invention with copolymers known in the art can be employed to form such compositions so as to control the dissolution rates. For example, in some embodiments 20 to 40 mole percent of the copolymer (or terpolymers) of this invention is blended with 60 to 80 mole percent of copolymer of norbornene-type repeat units and maleic repeat units known in the art. In some other embodiments 10 to 50 mole percent of the copolymer (or terpolymer) of this invention is blended with 50 to 90 mole percent of a copolymer known in the art, or any other amount that would bring about the intended benefit can be employed.

As used herein “dissolution rate” means the rate of dissolution of the “image-wise” exposed areas to suitable actinic radiation. Upon such actinic exposure, as noted above, the exposed areas become more soluble in the developing solvent. Accordingly, the dissolution rate is proportional to the percent developed. That is, higher the dissolution rate higher the percent developed. Accordingly, in some embodiments the composition comprising a blend containing at least 30 mole percent of a copolymer (or a terpolymer) according to this invention can be developed substantially fully, i.e., higher than 80 percent or higher than 90 percent or 100 percent developed. In some other embodiments the composition comprising a blend containing 20 to 30 mole percent of a copolymer according to this invention can be developed from about 50 percent to 80 percent or more.

The polymer compositions in accordance with the present invention may further contain optional components as may be useful for the purpose of improving properties of both the composition and the resulting layer, for example the sensitivity of the composition to a desired wavelength of exposure radiation. Examples of such optional components include various additives such as a dissolution promoter, a surfactant, a silane coupling agent, a leveling agent, an antioxidant, a fire retardant, a plasticizer, a crosslinking agent or the like. Such additives include, but are not limited to, bisphenol A and 5-norbornene-2,3-dicarboxylic acid as a dissolution promoter, a silicone surfactant such as TSF4452 (Toshiba Silicone Co., Ltd) or any other suitable surfactant such as Megaface F-556, a nonionic or anionic fluorinated oligomer with hydrophilic and lipophilic group from DIC Corp., a silane coupling agent, such as γ-aminopropyl triethoxysilane, a leveling agent, such as γ-(methacryloyloxy propyl) trimethoxysilane or FC-4432, 2-propenoic acid, 2-[methyl[(nonafluorobutyl) sulfonyl]amino]ethyl ester, telomer with methyloxirane polymer with oxirane di-2-propenoate and methyloxirane polymer with oxirane mono-propenoate from DIC, antioxidants, such as pentaerythritol tetrakis(3-(3,5-di-tert-butyl-4-hydroxyphenyl) propionate) (IRGANOX™ 1010 from BASF), 3,5-bis(1,1-dimethylethyl)-4-hydroxy-octadecyl ester benzenepropanoic acid (IRGANOX™ 1076 from BASF) and thiodiethylene bis[3-(3,5-di-tert.-butyl-4-hydroxy-phenyl) propionate](IRGANOX™ 1035 from BASF), a fire retardant, such as a trialkyl phosphate or other organic phosphoric compound and a plasticizer such as, poly(propylene glycol).

Non-limiting examples of aforementioned various other additives/components are selected from the group consisting of the following, commercially available materials are indicated by such commercial names.

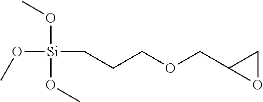

trimethoxy (3-(oxiran-2-ylmethoxy) propyl) silane, also commonly known as 3-glycidoxypropyl trimethoxysilane (KBM-403E from Shin-Etsu Chemical Co., Ltd.);

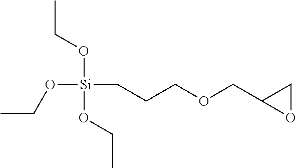 [SMILES: CCO[Si](CCCOCC1CO1)(OCC)OCC]

triethoxy (3-(oxiran-2-ylmethoxy) propyl) silane, also commonly known as 3-glycidoxypropyl triethoxysilane (KBE-403 from Shin-Etsu Chemical Co., Ltd.);

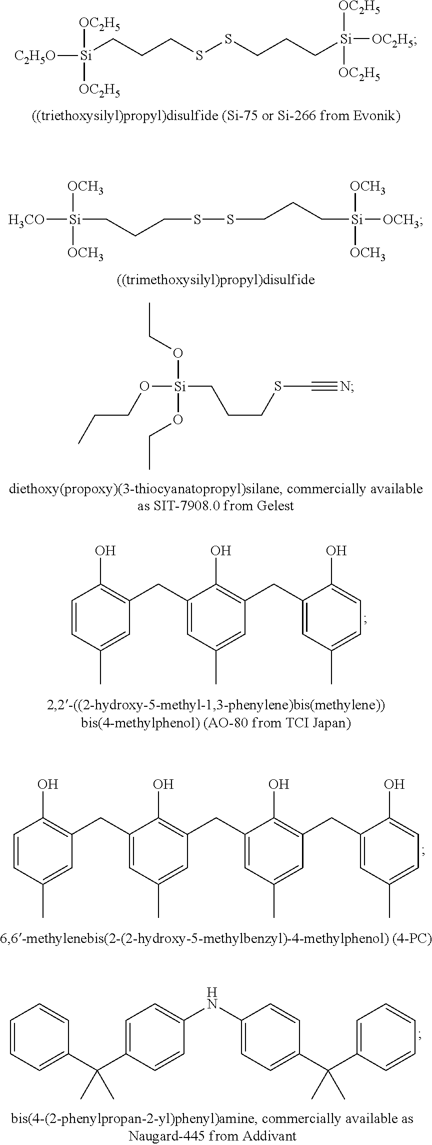

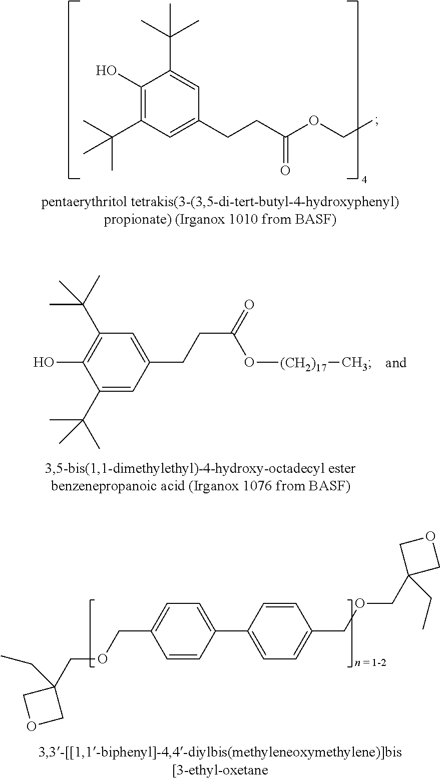

In the embodiments of the present invention, these components are generally dissolved in a solvent and prepared into a varnish form to be used. As a solvent, there may be used N-methyl-2-pyrrolidone (NMP), γ-butyrolactone (GBL), N,N-dimethylacetamide (DMAc), dimethylsulfoxide (DMSO), diethyleneglycol dimethyl ether, diethyleneglycol diethylether, diethyleneglycol dibutylether, propyleneglycol monomethylether (PGME), dipropylene glycol monomethylether, propyleneglycol monomethylether acetate (PGMEA), methyl lactate, ethyl lactate, butyl lactate, methyl ethyl ketone (MEK), methyl amyl ketone (MAK), cyclohexanone, tetrahydrofuran, methyl-1,3-butyleneglycolacetate, 1,3-butyleneglycol-3-monomethylether, methyl pyruvate, ethyl pyruvate, methyl-3-methoxypropionate or the like. They may be used solely or mixed by optionally selecting two or more kinds.

In one embodiment of the composition of this invention, the solvent used in forming the composition is selected form the group consisting of propyleneglycol monomethylether acetate (PGMEA), gamma-butyrolactone (GBL) and N-methylpyrrolidone (NMP) and a mixture in any combination thereof.

As mentioned above, some embodiments of the present invention encompass structures, such as optoelectronic structures, which include at least one self-imageable layer formed from a film of a polymer composition embodiment in accordance with the present invention.

The aforementioned structure embodiments of the present invention are readily formed by first casting or applying a polymer composition over an appropriate substrate to form a layer or a film thereof, then heating the substrate to an appropriate temperature for an appropriate time, where such time and temperature are sufficient to remove essentially all of the casting solvent of such composition. After such first heating, the layer is image-wise exposed to an appropriate wavelength of actinic radiation. As described hereinabove, the aforementioned image-wise exposure causes the PAC contained in the exposed portions of the layer to undergo a chemical reaction to form a free acid that enhances the dissolution rate of such exposed portions to an aqueous base solution (generally a solution of tetramethylammonium hydroxide (TMAH)). In this manner, such exposed portions are removed and unexposed portions remain. Next a second heating is performed to cause ring closure of the portions of the polymer and/or cross-linking with the epoxy additive, if present, thus essentially “curing” the polymer of such unexposed portions to form an aforementioned structure embodiment of the present invention.

It should be noted again that the second heating step, post development bake/curing is performed for the imaged and developed layer. In this step of second heating, the thermal curing of the polymer layer can be achieved with the added additives, such as epoxies and/or other crosslinking agents as described herein.

Accordingly, there is further provided a cured product obtained by curing the composition of this invention as described herein. In a further embodiment of this invention there is also provided an optoelectronic or microelectronic device encompassing the cured product of this invention, which exhibits improved thermo-mechanical properties as specifically described in the specific examples that follow.

The following examples, without being limiting in nature, illustrate methods for making composition embodiments in accordance with the present invention.

It should further be noted that the following examples are detailed descriptions of methods of preparation and use of certain compounds/monomers, polymers and compositions of the present invention. The detailed preparations fall within the scope of, and serve to exemplify, the more generally described methods of preparation set forth above. The examples are presented for illustrative purposes only, and are not intended as a restriction on the scope of the invention.

### EXAMPLES (GENERAL)

The following definitions have been used in the Examples that follow unless otherwise indicated: NB-norbornene; BuNB-5-butylbicyclo[2.2.1]hept-2-ene; NBTON-5-((2-(2-methoxyethoxy) ethoxy)methyl)bicyclo[2.2.1]hept-2-ene; NBCN-bicyclo[2.2.1]hept-5-ene-2-carbonitrile; MA-maleic anhydride; N-PhMI-N-phenyl maleimide; VG3101L-2,2′-((((1-(4-(2-(4-(oxiran-2-ylmethoxy)phenyl) propan-2-yl)phenyl) ethane-1,1-diyl)bis(4,1-phenylene))bis(oxy))bis(methylene))bis(oxirane), an epoxy crosslinking agent as disclosed herein; GE-36-triglycidyl ether of poly(oxypropylene) epoxide ether of glycerol, an epoxy crosslinking agent as disclosed herein; AIBN-azobisisobutyronitrile; CXC-1761-thermal base catalyst from King Industries Inc.; FC-4432 or MF-4432—a fluoro-surfactant—2-propenoic acid, 2-[methyl[(nonafluorobutyl) sulfonyl]amino]ethyl ester, telomer with methyloxirane polymer with oxirane di-2-propenoate and methyloxirane polymer with oxirane mono-propenoate; KBM-403E: trimethoxy (3-(oxiran-2-ylmethoxy) propyl) silane, also commonly known as 3-glycidoxypropyl trimethoxysilane; TrisP3M6C-2-201: a photoactive compound of formula (Vo) in which Q is of formula (IVA); THF—tetrahydrofuran; NMP—N-methyl-2-pyrrolidone; DMSO—dimethyl sulfoxide; DMAc—dimethyl acetamide; PGMEA—propyleneglycol monomethylether acetate; TMAH—tetramethyl ammonium hydroxide; Zeonex 480 and Topas 6013S-04—commercially available norbornene based polymers; PTFE—polytetrafluoroethylene; HDPE—high density polyethylene; GPC-gel permeation chromatography; M_{w}—weight average molecular weight; Mₙ—number average molecular weight; PDI—polydispersity index; pphr—parts per hundred resin; FT-IR—Fourier transform-infrared spectroscopy; NMR—nuclear magnetic resonance; TMA—thermomechanical analysis.

### Polymers

The polymers of this invention are prepared generally in accordance with the well-known literature procedures, such as for example free radical initiated solution polymerization. See U.S. Pat. No. 9,834,627, pertinent portions of which are incorporated herein by reference. Pure exo and endo isomers of NBCN were obtained by fractional distillation of monomer mixtures as described in U.S. Pat. No. 7,662,996. The following examples are further provided to illustrate the preparation of several of the copolymers and terpolymers as described herein.

### Example 1

### Exo/Endo-NBCN/MA Copolymer

A solution of MA (9.8 g, 100 mmol) and exo/endo-NBCN (11.9 g, 100 mmol) in ethyl acetate (22.8 g) was placed in an appropriately sized reaction vessel equipped with a nitrogen inlet/outlet, water-cooling condenser and a port for a thermocouple. The solution was heated to 65° C., and AIBN (1.09 g, 0.66 mmol) was added. The reaction mixture was then maintained at 65° C. for 6 hours while stirring under nitrogen atmosphere and after which the solution was cooled to room temperature. THF (50 g) was added and the solid polymer was separated out of the solution by adding the reaction mixture to heptanes (250 g) and washed with excess heptanes, filtered and dried in a vacuum oven at 65° C. overnight to obtain exo/endo-NBCN/MA copolymer (8 g, 37% yield). The molecular weight of the resulting polymer was determined by GPC (THF): M_{w}=8,250, Mₙ=4,700, PDI=1.75. FT-IR characterization of the solid polymer showed a peak at 2238 cm⁻¹ indicating the presence of the nitrile group and peaks at 1777 cm⁻¹ and 1849 cm⁻¹ indicating the presence of cyclic anhydride structure from MA. 13C-NMR spectra obtained in deuterated DMSO showed broad peaks at 120-125 ppm for —CN group and 170-177 ppm for cyclic anhydride groups. Exo/endo-NBCN/MA composition of 57/43 was calculated based on 13C-NMR peak integrations.

### Example 2

### Exo-NBCN/MA Copolymer

The procedures of Example 1 were substantially repeated in this Example 2 except for using pure exo-NBCN to obtain the title polymer (4.5 g, 21% yield). The molecular weight of the resulting polymer was determined by GPC (THF): M_{w}=7,650, Mₙ=4,700, PDI=1.75. FT-IR characterization of the solid polymer showed a peak at 2238 cm⁻¹ indicating the presence of the nitrile group and peaks at 1774 cm⁻¹ and 1849 cm⁻¹ indicating the presence of cyclic anhydride structure from MA. 13C-NMR spectra obtained in deuterated DMSO showed broad peaks at 120-125 ppm for —CN group and 170-177 ppm for cyclic anhydride groups. Exo-NBCN/MA composition of 53/47 was calculated based on 13C-NMR peak integrations.

### Example 3

### Exo/Endo-NBCN/MA Copolymer

The procedures of Example 1 were substantially repeated in this Example 3 except for using a longer reaction time of 48 hours to obtain the title polymer (16.5 g, 76% yield). The molecular weight of the resulting polymer was determined by GPC (DMAc): M_{w}=6,600, Mₙ=4,350, PDI=1.52. FT-IR characterization of the solid polymer showed a peak at 2239 cm⁻¹ indicating the presence of the nitrile group and peaks at 1777 cm⁻¹ and 1847 cm⁻¹ indicating the presence of cyclic anhydride structure from MA. 13C-NMR spectra obtained in deuterated DMSO showed broad peaks at 120-125 ppm for —CN group and a broad peak at 170-177 ppm for cyclic anhydride groups. Exo/endo-NB/MA composition of 54/46 was calculated based on 13C-NMR peak integrations.

### Example 4

### Exo/Endo-NBCN/BuNB/MA Terpolymer

MA (9.8 g, 100 mmol), BuNB (7.5 g, 50 mmol), NBCN (5.95 g, 50 mmol) and AIBN (1.09 g, 0.66 mmol) were dissolved in ethyl acetate (16.9 g) in a glass crimp-cap vial. The solution was sparged with nitrogen for 10 min to remove oxygen and then heated to about 70° C. for 48 hours and after which the solution was cooled to room temperature. The solid polymer was separated out of a portion of the reaction mixture (1 g) by adding it to heptanes (10 g) and washed with excess heptanes, filtered and dried in a vacuum oven at 60° C. for 18 hrs to obtain the NBCN/BuNB/MA terpolymer (0.5 g, 90% yield). The molecular weight of the resulting polymer was determined by GPC (THF): M_{w}=5,200, Mₙ=3,025, PDI=1.72. FT-IR characterization of the solid polymer showed a peak at about 2240 cm⁻¹ indicating the presence of the nitrile group and peaks at 1777 cm⁻¹ and 1851 cm⁻¹ indicating the presence of cyclic anhydride structure from MA.

### Example 5

### Exo/Endo-NBCN/NBTON/MA Terpolymer

MA (9.8 g, 100 mmol), NBTON (11.3 g, 50 mmol), NBCN (5.95 g, 50 mmol) and AIBN (1.09 g, 0.66 mmol) were dissolved in ethyl acetate (16.9 g) in a glass crimp-cap vial. The solution was sparged with nitrogen for 10 min to remove oxygen and then heated to about 70° C. for 48 hours and after which the solution was cooled to room temperature. The solid polymer was separated out of a portion of the reaction mixture (1 g) by adding it to heptanes (10 g) and washed with excess heptanes, filtered and dried in a vacuum oven at 60° C. for 18 hrs to obtain the NBCN/NBTON/MA terpolymer (0.5 g, 90% yield). The molecular weight of the resulting polymer was determined by GPC (THF): M_{w}=5,800, Mₙ=3,200, PDI=1.81. FT-IR characterization of the solid polymer showed a weak peak at about 2240 cm⁻¹ indicating the presence of the nitrile group and peaks at 1777 cm⁻¹ and 1850 cm⁻¹ indicating the presence of cyclic anhydride structure from MA.

### Example 6

### Exo/Endo-NBCN/N-PhMI Copolymer

N-PhMI, 13 g, 75 mmol), NBCN (8.93 g, 75 mmol) and AIBN (0.82 g, 0.5 mmol) were dissolved in ethyl acetate (21.1 g) in a glass crimp-cap vial. The solution was sparged with nitrogen for 10 min to remove oxygen and then heated to about 70° C. for 24 hours and after which the solution was cooled to room temperature. The molecular weight of the resulting polymer was determined by GPC (THF): M_{w}=4,500, Mₙ=2,500, PDI=1.79. The solid polymer was separated out of a portion of the reaction mixture (1 g) by adding it to heptanes (10 g) and washed with excess heptanes, filtered and dried in a vacuum oven at 80° C. for 15 hrs. FT-IR characterization of the solid polymer showed a peak at 2236 cm⁻¹ indicating the presence of the nitrile group and peaks at 1714 cm⁻¹ and 1779 cm⁻¹ indicating the presence of cyclic maleimide structure from N-PhMI.

### Example 7

### Exo/Endo-NBCN/BuNB/N-PhMI Terpolymer

N-phenyl maleimide (N-PhMI, 13 g, 75 mmol), NBCN (4.46 g, 37.5 mmol), BuNB (5.63 g, 37.5 mmol) and AIBN (0.82 g, 0.5 mmol) were dissolved in ethyl acetate (22.2 g) in a glass crimp-cap vial. The solution was sparged with nitrogen for 10 min to remove oxygen and then heated to about 70° C. for 24 hours and after which the solution was cooled to room temperature. The molecular weight of the resulting polymer was determined by GPC (THF): M_{w}=6,200, Mₙ=3,050, PDI=1.83. The solid polymer was separated out of a portion of the reaction mixture (1 g) by adding it to heptanes (10 g) and washed with excess heptanes, filtered and dried in a vacuum oven at 80° C. for 15 hrs. FT-IR characterization of the solid polymer showed a peak at 2236 cm⁻¹ indicating the presence of the nitrile group and peaks at 1719 cm⁻¹ and 1779 cm⁻¹ indicating the presence of cyclic maleimide structure from N-PhMI.

### Example 8

### Endo/Exo-NBCN/NBTON/N-PhMI Terpolymer

N-phenyl maleimide (N-PhMI, 13 g, 75 mmol), NBCN (4.46 g, 37.5 mmol), NBTON (8.48 g, 37.5 mmol) and AIBN (0.82 g, 0.5 mmol) were dissolved in ethyl acetate (25.1 g) in a glass crimp-cap vial. The solution was sparged with nitrogen for 10 min to remove oxygen and then heated to about 70° C. for 24 hours and after which the solution was cooled to room temperature. The molecular weight of the resulting polymer was determined by GPC (THF): M_{w}=4,900, Mₙ=2,750, PDI=1.77. The solid polymer was separated out of a portion of the reaction mixture (1 g) by adding it to heptanes (10 g) and washed with excess heptanes, filtered and dried in a vacuum oven at 80° C. for 15 hrs. FT-IR characterization of the solid polymer showed a peak at 2236 cm⁻¹ indicating the presence of the nitrile group and peaks at 1712 cm⁻¹ and 1778 cm⁻¹ indicating the presence of cyclic maleimide structure from N-PhMI.

### Example 9

### Composition of Exo/Endo-NBCN/MA Copolymer

NBCN/MA copolymer from Example 3 was used to form the composition of Example 9, which included the following: TrisP3M6C-2-201 (30 pphr) as a photo-active compound, VG3101L (30 pphr) and GE-36 (30 pphr) as epoxide cross-linkers, KBM-403E (5 pphr) as an adhesion promoter, CXC-1761 (0.5 pphr) as a cure catalyst, MF-4432 (0.3 pphr) as a surface leveling agent and PGMEA (236 pphr) as the solvent were mixed in an appropriately sized amber HDPE bottles. The mixture was rolled for 18 hours to produce homogeneous solution. Particle contamination was removed by filtering the composition through 0.2 μm pore polytetrafluoroethylene (PTFE) disc filters. The filtered composition was collected in low particle HDPE amber bottle and stored at 5° C.

### Examples 10A-10C

### Compositions of Exo/Endo-NBCN/MA Copolymer

Varied amounts of NB/MA copolymer from Comparative Example 1 was mixed with NBCN/MA copolymer from Example 1 to prepare the compositions of Examples 10A to 10C, each of which contained specific amounts of additives as follows: TrisP3M6C-2-201 (35 phr) as a photo-active compound, VG3101L (30 phr) and GE-36 (30 phr) as epoxide cross-linkers, KBM-403E (5 phr) as an adhesion promoter, CXC-1761 (0.50 phr) as a cure catalyst, MF-4432 (0.3 phr) as a surface leveling agent and PGMEA (262 phr) and NMP (66 phr) as a mixture of solvents. The compositions thus formed were mixed in an appropriately sized amber HDPE bottles. The composition of Example 10A contained a mixture of NB/MA copolymer (80 weight %) and NBCN/MA copolymer (20 weight %), composition of Example 10B contained a mixture of NB/MA copolymer (67 weight %) and NBCN/MA copolymer (33 weight %) and the composition of Example 10C contained only NBCN/MA (100 weight %). Each of the compositions contained in the HDPE bottles was rolled for 18 hours to produce homogeneous solution. Particle contamination was removed by filtering the composition through 0.2 μm pore polytetrafluoroethylene (PTFE) disc filter. The filtered compositions were collected in low particle HDPE amber bottles and stored at 5° C.

### Example 11

### Water Contact Angle Measurement

Exo/endo-NBCN/MA and NB/MA, polymer coatings were prepared on silicon wafers by spin coating each of the polymer solutions in PGMEA. Similarly, Zeonex 480 and Topas 6013S-04 polymer coatings were prepared on silicon wafers by spin coating each of the polymer solutions in p-menthane. Water contact angles of 50 μl water droplets placed on the film surfaces were measured using a Goniometer by ramé-hart Instrument Co. The water contact angle (CA) values reported in Table 1 demonstrates that NBCN/MA films are substantially more hydrophilic than NB/MA, Zeonex 480 or Topas 6013S-04 films.

TABLE 1

| | Exo/endo- | | | Topas |
|---|---|---|---|---|
| Polymer | NBCN/MA | NB/MA | Zeonex 480 | 6013S-04 |
| CA | 55° | 70° | 98° | 101° |

CA—water contact angle

### Example 12

### Resistance to Oil Properties

Exo/endo-NBCN/MA polymer coatings were prepared on silicon wafers by spin coating each of the polymer solutions in PGMEA. Similarly, Zeonex 480 and Topas 6013S-04 polymer coatings were prepared on silicon wafers by spin coating each of the polymer solutions in p-menthane. The films were immersed in commercial olive oil for 5 minutes. Table 2 shows film thicknesses (FT) before and after olive oil immersion and the appearance of the films after olive oil immersion. It is evident from the results summarized in Table 2 that the films formed from NBCN/MA copolymer are substantially more resistant to olive oil than the films formed from either Zeonex 480 or Topas 6013S-04.

TABLE 2

| | Exo/endo- | | |
|---|---|---|---|
| Polymer | NBCN/MA | Zeonex 480 | Topas 6013S-04 |
| FT (before immersion) | 0.60 μm | 1.61 μm | 1.65 μm |
| FT (after immersion) | 0.57 μm | — | — |
| Film appearance | Film intact | Pieces of film | Pieces of film |
| (after immersion) | | removed from | removed from |
| | | wafer | wafer |

FT—film thickness

### Example 13

### UV/VIS Transparency Measurements

Exo/endo-NBCN/MA and NB/MA polymer coatings were prepared on glass wafers by spin coating each of the polymer solutions in PGMEA. Similarly, Zeonex 480 and Topas 6013S-04 polymer coatings were prepared on silicon wafers by spin coating each of the polymer solutions in p-menthane. UV/Vis spectra of these films were measured at 200-800 nm wavelength range and is shown in FIG. 1. Although some absorptions were evident in the UV region (200 to 380 nm) the NBCN/MA films is substantially transparent as the films of Zeonex 480 or Topas 6013S-04 in the visible wavelength range when the transparencies are normalized to 1 μm film thickness.

### Example 14

### Photo Imaging Studies

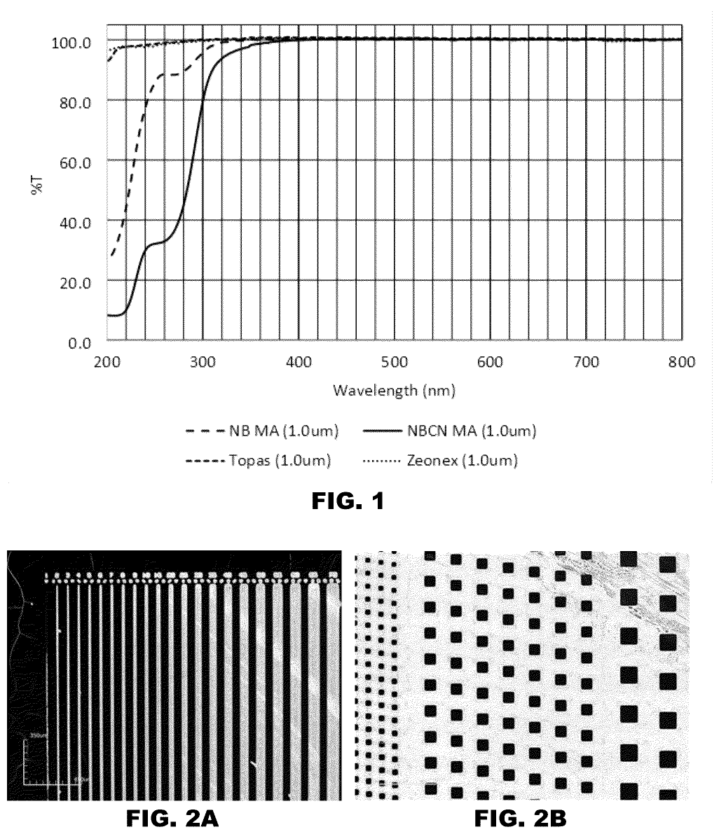

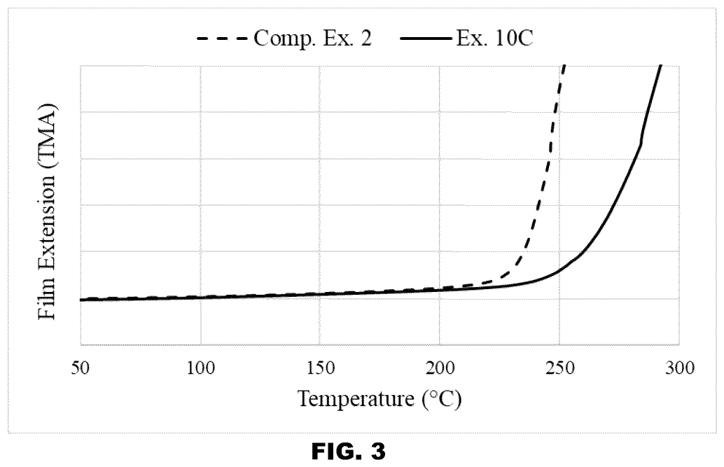

Each of the compositions from Example 9, Example 10 and Comparative Example 2 was spin coated at a spin speed of 600-700 rpm for 30 seconds on a 4-inch thermal oxide silicon wafer. The coated film was post apply baked (PAB) at 105° C. on a hot plate for 3 minutes to obtain a film thickness in the range of 7.6 to 13.7 μm. The film was then exposed using a combination of a patterned mask and a variable density mask to a broad band Hg-vapor light source (at 365 nm using a band pass filter). The film was developed for 15 seconds to 60 seconds with 2.4 wt. % TMAH in a puddle, rinsed with distilled water and dried using a stream of nitrogen. A positive tone image was formed and observed under an optical microscope. Trenches were formed in 2 μm resolution and pillars were formed in 25 μm resolution at 204 mJ/cm² dose. FIG. 2A shows the formation of trenches of 2 μm or above and FIG. 2B shows 25, 50 and 75 μm square pillars formed from the composition of Example 9. The film thickness (FT) in the unexposed area after development was 1.5 μm. The unexposed film thickness loss or dark field loss (DFL) of 79% was calculated based on film thicknesses before and after development. The photo imaging properties of all of the compositions of Example 9 and Example 10 are summarized in Table 3. It is evident from the results presented in Table 3 the composition of Example 10B which contained a mixture of 33 wt. % of NBCN/MA copolymer and 67 wt. % NB/MA copolymer resulted not only in a higher degree of development but also retained higher film thickness in the unexposed areas thus offering significant advantages over NB/MA copolymer. It should further be noted that unlike photo imageability of the compositions of this invention as seen for the compositions of Examples 9 and 10, the composition of Comparative Example 2 does not demonstrate photo imaging efficacy when developed with an aqueous base developer such as 2.4 wt. % TMAH.

TABLE 3

| Composition | NBCN/MA | NB/MA | FT | Develop | FT | FT | % |
|---|---|---|---|---|---|---|---|
| Example No. | (%) | (%) | (μm) | time (sec) | (unexposed) | (exposed) | Developed |
| Comp. Ex. 2 | 0 | 100 | 7.62 | 60 | 7.6 | 5.7 | 25 |
| Example 10A | 20 | 80 | 11.4 | 60 | 11.5 | 5.1 | 55 |
| Example 10B | 33 | 67 | 13.7 | 30 | 13.4 | 2.3 | 83 |
| Example 9 | 100 | 0 | 11.7 | 15 | 1.5 | 0 | 100 |

FT—film thickness

### Example 14

### Thermo-Mechanical Analysis (TMA)

Each of the compositions from Example 9, Example 10 and Comparative Example 2 was spin coated at a spin speed to 400-600 rpm for 30 seconds on 5-inch silicon wafers. The coated films were post apply baked (PAB) at 105° C. on a hot plate for 3 minutes to obtain films of about 9-11 μm thicknesses. These films were cured in an oven under nitrogen atmosphere at 200° C. for 2 hours to obtain cured films. Glass transition temperatures (T_{g}) of the cured films were determined by TMA technique. The glass transition temperature of the film obtained by the composition of Example 9 was 260° C. (broad glass transition) and of the film formed from the composition Example 10C was 240° C. (broad glass transition) while that of the film obtained from composition of Comparative Example 2 was 232° C. demonstrating that the glass transition temperatures of cured films from the composition of this invention containing NBCN/MA copolymer is about 12-32° C. higher than that of NB/MA. FIG. 3 compares the glass transitions observed by TMA for the film formed from the composition of Example 10C and the film formed from the composition of Comparative Example 2. The coefficient of thermal expansion (CTE) of the cured films and their wafer stresses (measured after at least 24 hour delay) are summarized in Table 4.

TABLE 4

| | | | | | Wafer |
|---|---|---|---|---|---|
| Composition | NBCN/MA | NB/MA | T_{g} | CTE | Stress |
| Example No. | (%) | (%) | (° C.) | (ppm/K) | (MPa) |
| Comp. Ex. 2 | 0 | 100 | 222 | 42 | 28.5 ± 0.7 |
| Example 10A | 20 | 80 | 227 | 42 | 29.5 ± 0.7 |
| Example 10B | 33 | 67 | 230 | 37 | 29.5 ± 0.7 |
| Example 10C | 100 | 0 | 240 | 57 | 26.5 ± 0.7 |
| | | | (broad) | | |
| Example 9 | 100 | 0 | 260 | 31 | 22.5 ± 2.5 |
| | | | (broad) | | |

Tg—glass transition temperature;
CTE—coefficient of thermal expansion

### Comparative Example 1

### NB/MA Copolymer

A solution of MA (103 g, 105 mmol) and NB (98.9 g, 105 mmol) in cyclopentanone (462.7 g) was placed in an appropriately sized reaction vessel equipped with a nitrogen inlet/outlet, water-cooling condenser and a port for a thermocouple. The mixture was heated to 65° C., and lauryl peroxide (8.37 g, 2.1 mmol) was added. The reaction mixture was then heated at 70° C. for 6 hrs while stirring under nitrogen atmosphere and after which the solution was cooled to room temperature. Solid polymer (335 g) was separated out of the solution by adding the reaction mixture to excess heptanes and washed with excess heptanes, filtered and dried in a vacuum oven at 50° C. overnight. The molecular weight of the resulting polymer was determined by GPC (DMAc): M_{w}=13,500, Mₙ=7,250, PDI=1.86. FT-IR characterization of the solid polymer did not show a peak at 2238 cm⁻¹ indicating the absence of the nitrile group and peaks at 1778 cm⁻¹ and 1851 cm⁻¹ indicating the presence of cyclic anhydride structure from MA. 13C-NMR spectra obtained in deuterated DMSO did not show peaks at 120-125 ppm for —CN group but there was a broad peak at 170-177 ppm for cyclic anhydride groups. NB/MA composition of 51/49 was calculated based on 13C-NMR peak integrations.

### Comparative Example 2

### NB/MA Copolymer Composition

NB/MA copolymer from Comparative Example 1 was used to form the composition of Comparative Example 2 having the specific amounts of additives as follows: TrisP3M6C-2-201 (35 phr) as a photo-active compound, VG3101L (30 phr) and GE-36 (30 phr) as epoxide cross-linkers, KBM-403E (5 phr) as an adhesion promoter, CXC-1761 (0.5 phr) as a cure catalyst, MF-4432 (0.3 phr) as a surface leveling agent and PGMEA (262 phr) and NMP (66 phr) as a mixture of solvents. The composition was mixed in an appropriately sized amber HDPE bottle. The composition was rolled for 18 hours to produce homogeneous solution. Particle contamination was removed by filtering the composition through 0.2 μm pore polytetrafluoroethylene (PTFE) disc filter. The filtered composition was collected in low particle HDPE amber bottle and stored at 5° C.

Although the invention has been illustrated by certain of the preceding examples, it is not to be construed as being limited thereby; but rather, the invention encompasses the generic area as hereinbefore disclosed. Various modifications and embodiments can be made without departing from the spirit and scope thereof.

1. A composition comprising:
a) a polymer comprising:
i) one or more distinct first repeating unit of formula (IA), each of said first repeating unit is derived from a monomer of formula (I): 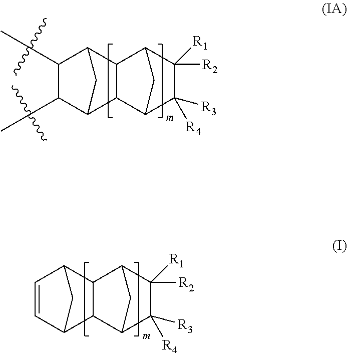
wherein: [symbol]
represents a position at which the bonding takes place with another repeat unit;
m is an integer 0, 1 or 2;
at least one of R₁, R₂, R₃ and R₄ is —CN or —R₅CN, where R₅ is selected from the group consisting of (C₁-C₁₀)alkylene, (C₃-C₈) cycloalkylene, (C₁-C₁₀)alkylene (C₃-C₈) cycloalkylene, (C₁-C₁₀)alkylene (C₃-C₈) cycloalkylene (C₁-C₁₀)alkylene, (C₁-C₁₀)alkylene (C₆-C₁₀)arylene and (C₁-C₁₀)alkylene (C₆-C₁₀)arylene (C₁-C₁₀)alkylene; and
the remaining R₁, R₂, R₃ and R₄ are the same or different and independently of each other selected from the group consisting of hydrogen, methyl, ethyl, linear or branched (C₃-C₁₀)alkyl, (C₃-C₈) cycloalkyl, (C₁-C₁₀)alkyl(C₃-C₈) cycloalkyl and (C₁-C₁₀)alkyl(C₆-C₁₀)aryl;
ii) one or more distinct second repeating unit of formula (IIA), each of said second repeating unit is derived from a monomer of formula (II): 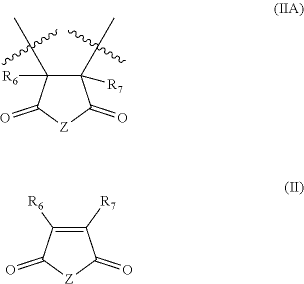
wherein: [symbol]
represents a position at which the bonding takes place with another repeat unit;
Z is O or NR₈, where R₈ is selected from the group consisting of hydrogen, (C₁-C₁₀)alkyl, (C₃-C₈) cycloalkyl, (C₁-C₁₀)alkylene (C₃-C₈) cycloalkyl, (C₁-C₁₀)alkylene (C₃-C₈) cycloalkylene (C₁-C₁₀)alkyl, (C₆-C₁₀)aryl, (C₁-C₁₀)alkylene (C₆-C₁₀)aryl and (C₁-C₁₀)alkylene (C₆-C₁₀)arylene (C₁-C₁₀)alkyl; and
each of R₆ and R₇ is independently selected from the group consisting of hydrogen, methyl, ethyl, linear or branched (C₃-C₉)alkyl and fluorinated or perfluorinated (C₁-C₉)alkyl;
b) a photoactive compound;
c) an epoxy crosslinking agent; and
d) a carrier solvent.

2. The composition according to claim 1, wherein said polymer further comprises one or more distinct third repeat unit of formula (IIIA) derived from a monomer of formula (III): 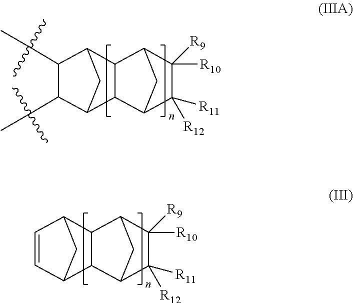
wherein: [symbol]
represents a position at which the bonding takes place with another repeat unit;
n is an integer 0, 1 or 2; and
each of R₉, R₁₀, R₁₁ and R₁₂ is independently selected from the group consisting of
hydrogen, linear or branched (C₁-C₁₆)alkyl, hydroxy (C₁-C₁₂)alkyl, perfluoro (C₁-C₁₂)alkyl, (C₃-C₁₂) cycloalkyl, (C₆-C₁₂)bicycloalkyl, (C₇-C₁₄)tricycloalkyl, (C₆-C₁₀)aryl, (C₆-C₁₀)aryl(C₁-C₃)alkyl, perfluoro (C₆-C₁₀)aryl, perfluoro (C₆-C₁₀)aryl(C₁-C₃)alkyl, (C₅-C₁₀) heteroaryl, (C₅-C₁₀) heteroaryl(C₁-C₃)alkyl, hydroxy, (C₁-C₁₂)alkoxy, (C₃-C₁₂)cycloalkoxy, (C₆-C₁₂)bicycloalkoxy, (C₇-C₁₄)tricycloalkoxy, —(CH₂)ₐ—(O—(CH₂)_{b})_{c}—O—(C₁-C₄)alkyl, where a, b and c are integers from 1 to 4, (C₆-C₁₀)aryloxy (C₁-C₃)alkyl, (C₅-C₁₀)heteroaryloxy (C₁-C₃)alkyl, (C₆-C₁₀)aryloxy, (C₅-C₁₀)heteroaryloxy, (C₁-C₆)acyloxy and halogen.

3. The composition according to claim 1, wherein said polymer comprises one or more distinct repeating units of formula (IA) wherein,
m is 0 or 1;
at least one of R₁, R₂, R₃ and R₄ is —CN;
the remaining R₁, R₂, R₃ and R₄ is independently selected from the group consisting of hydrogen, methyl, ethyl, linear or branched (C₃-C₆)alkyl and phenyl(C₁-C₃)alkyl;
Z is O or NR₈, where R₈ is selected from the group consisting of hydrogen, methyl, ethyl, n-propyl, iso-propyl, n-butyl, iso-butyl, cyclopentyl, cyclohexyl, cycloheptyl, phenyl, benzyl and phenethyl; and
R₆ and R₇ independently of each other selected from the group consisting of hydrogen and methyl.

4. The composition according to claim 2, wherein said polymer comprises one or more distinct repeating units of formula (IIIA) wherein:
n is 0 or 1;
each of R₉, R₁₀, R₁₁ and R₁₂ is independently selected from the group consisting of hydrogen, methyl, ethyl, linear or branched (C₃-C₁₂)alkyl, phenyl(C₁-C₃)alkyl, (CH₂)ₐ—(O—(CH₂)_{b})_{c}—O—(C₁-C₄)alkyl, where a is 1, b is 2 and c is 2 or 3.

5. The composition according to claim 1, wherein said polymer is having one or more distinct first repeating unit of formula (IA) derived from a respective monomer of formula (I) selected from the group consisting of:

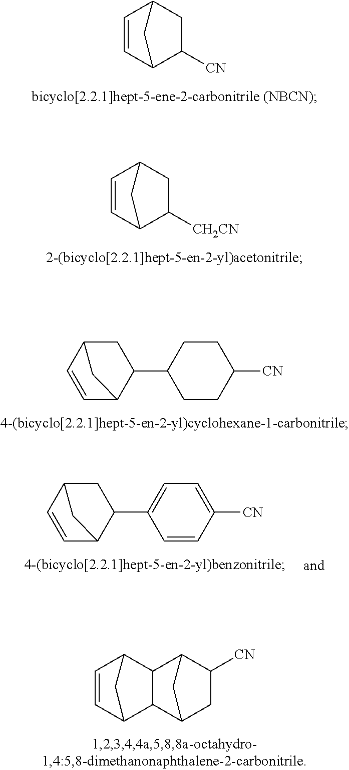

6. The composition according to claim 1, wherein said polymer is having one or more distinct second repeating unit of formula (IIA) derived from a respective monomer of formula (II) selected from the group consisting of:

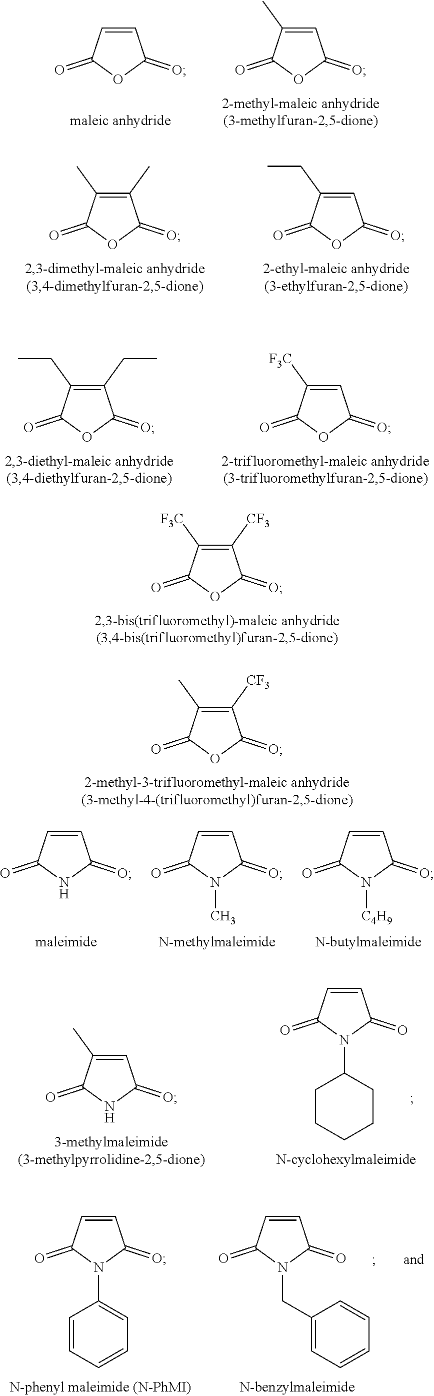

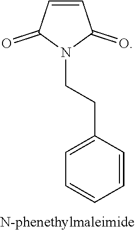

7. The composition according to claim 2, wherein said polymer is having one or more distinct third repeating unit of formula (IIIA) derived from a respective monomer of formula (III) selected from the group consisting of:

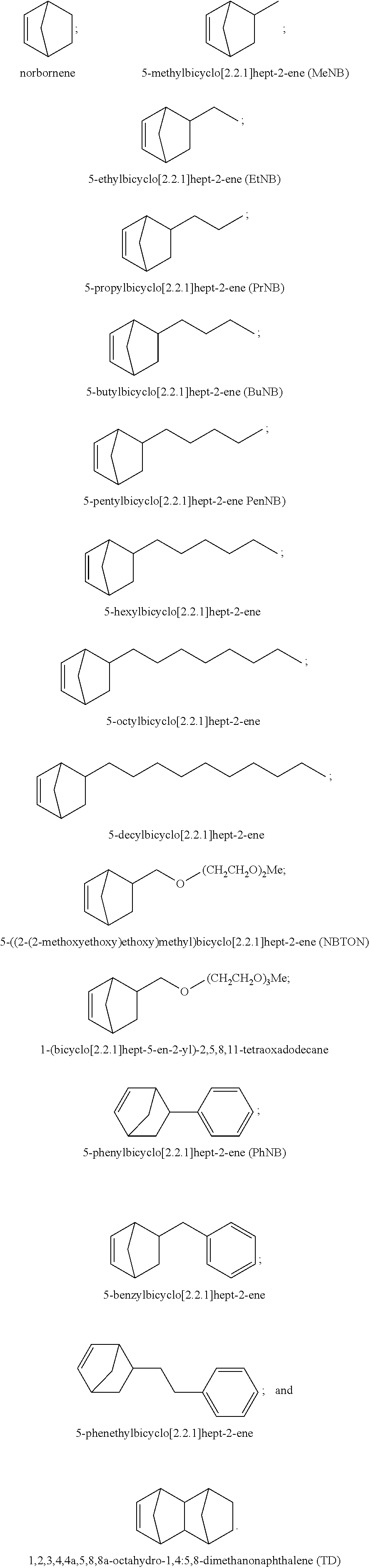

8. The composition according to claim 1, wherein said polymer is selected from the group consisting of:
a copolymer of bicyclo[2.2.1]hept-5-ene-2-carbonitrile (NBCN) and maleic anhydride;
a copolymer of bicyclo[2.2.1]hept-5-ene-2-carbonitrile (NBCN) and N-phenyl maleimide (N-PhMI);
a copolymer of bicyclo[2.2.1]hept-5-ene-2-carbonitrile (NBCN) and 2-methyl-maleic anhydride;
a copolymer of bicyclo[2.2.1]hept-5-ene-2-carbonitrile (NBCN) and N-cyclohexyl maleimide; and
a copolymer of bicyclo[2.2.1]hept-5-ene-2-carbonitrile (NBCN) and N-methyl maleimide.

9. The composition according to claim 2, wherein said polymer is selected from the group consisting of:
a terpolymer of bicyclo[2.2.1]hept-5-ene-2-carbonitrile (NBCN), norbornene (NB) and maleic anhydride;
a terpolymer of bicyclo[2.2.1]hept-5-ene-2-carbonitrile (NBCN), 5-butylbicyclo[2.2.1]hept-2-ene (5-butylnorbornene, BuNB) and maleic anhydride;
a terpolymer of bicyclo[2.2.1]hept-5-ene-2-carbonitrile (NBCN), 5-((2-(2-methoxyethoxy) ethoxy)methyl)bicyclo[2.2.1]hept-2-ene (NBTON) and maleic anhydride;
a terpolymer of bicyclo[2.2.1]hept-5-ene-2-carbonitrile (NBCN), 5-butylbicyclo[2.2.1]hept-2-ene (5-butylnorbornene, BuNB) and N-phenyl maleimide (N-PhMI); and
a terpolymer of bicyclo[2.2.1]hept-5-ene-2-carbonitrile (NBCN), 5-((2-(2-methoxyethoxy) ethoxy)methyl)bicyclo[2.2.1]hept-2-ene (NBTON) and N-phenyl maleimide (N-PhMI).

10. The composition according to claim 1, wherein said photoactive compound comprises one or more of a 1,2-naphthoquinonediazide-5-sulfonyl moiety, 1,2-naphthoquinonediazide-4-sulfonyl moiety as represented by structural formulae (IVA) and (IVB), respectively: 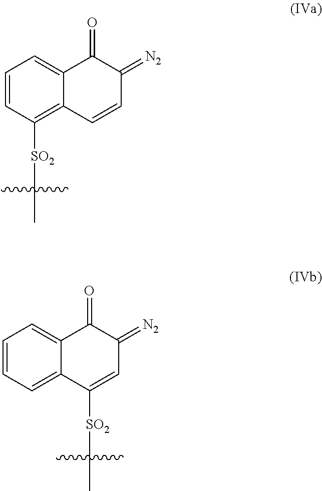
or a sulfonyl benzoquinone diazide group represented by structural formula (IVC):

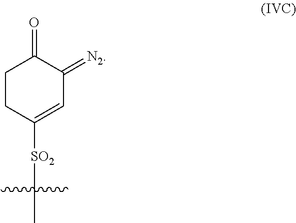

11. The composition according to claim 11, wherein said photoactive compound is selected from the group consisting of: 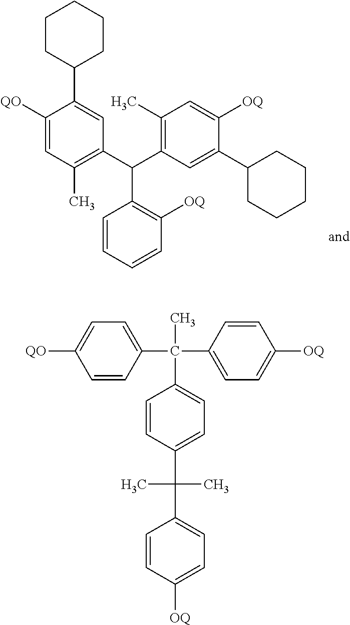
wherein at least one of Q is a group of formula (IVA) or (IVB): 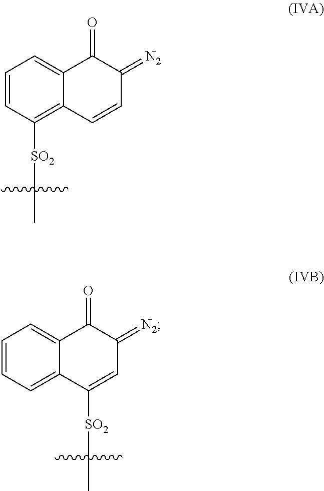
and the remaining Q is hydrogen.

12. The composition according to claim 1, wherein said epoxy crosslinking agent is selected from the group consisting of: 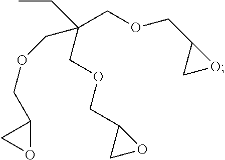 [SMILES: CCC(COCC1CO1)(COCC1CO1)COCC1CO1] 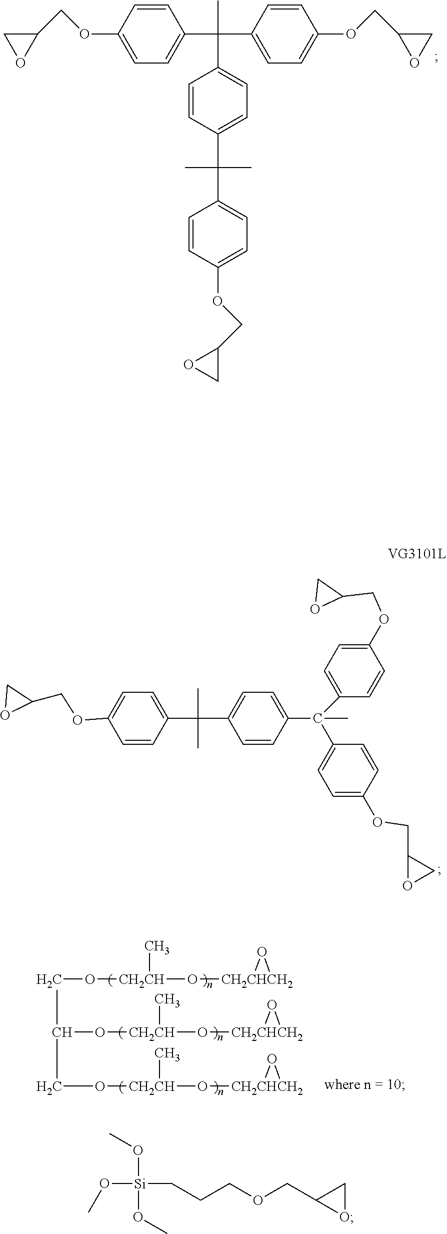
and a mixture in any combination thereof.

13. The composition according to claim 1, wherein said solvent is selected from the group consisting of propyleneglycol monomethylether acetate (PGMEA), N-methylpyrrolidone (NMP), γ-butyrolactone (GBL) and a mixture in any combination thereof.

14. The composition according to claim 1, wherein said composition further comprises one or more additives selected from the group consisting of:
adhesion promoter;
cure catalyst;
surface leveling agent; and
mixtures in any combination thereof.

15. A polymer comprising:
a) one or more distinct first repeating unit represented by formula (IA), each of said first repeating unit is derived from a monomer of formula (I): 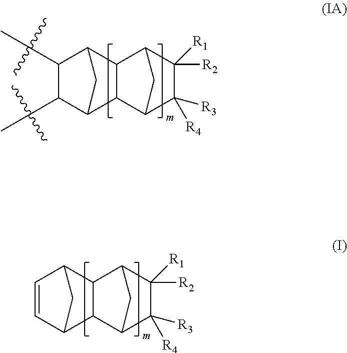
wherein: [symbol]
represents a position at which the bonding takes place with another repeat unit;
m is an integer 0, 1 or 2;
at least one of R₁, R₂, R₃ and R₄ is —CN or —R₅CN, where R₅ is selected from the group consisting of (C₁-C₁₀)alkylene, (C₃-C₈) cycloalkylene, (C₁-C₁₀)alkylene (C₃-C₈) cycloalkylene, (C₁-C₁₀)alkylene (C₃-C₈) cycloalkylene (C₁-C₁₀)alkylene, (C₁-C₁₀)alkylene (C₆-C₁₀)arylene and (C₁-C₁₀)alkylene (C₆-C₁₀)arylene (C₁-C₁₀)alkylene;
the remaining R₁, R₂, R₃ and R₄ are the same or different and independently of each other selected from the group consisting of hydrogen, methyl, ethyl, linear or branched (C₁-C₁₀)alkyl, (C₃-C₈) cycloalkyl, (C₁-C₁₀)alkyl(C₃-C₈) cycloalkyl and (C₁-C₁₀)alkyl(C₆-C₁₀)aryl;
b) one or more distinct second repeating unit represented by formula (IIA), each of said second repeating unit is derived from a monomer of formula (II): 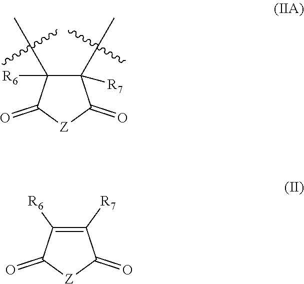
wherein: [symbol]
represents a position at which the bonding takes place with another repeat unit;
Z is O or NR₈, where R₈ is selected from the group consisting of hydrogen, (C₁-C₁₀)alkyl, (C₃-C₈) cycloalkyl, (C₁-C₁₀)alkylene (C₃-C₈) cycloalkyl, (C₁-C₁₀)alkylene (C₃-C₈) cycloalkylene (C₁-C₁₀)alkyl, (C₆-C₁₀)aryl, (C₁-C₁₀)alkylene (C₆-C₁₀)aryl and (C₁-C₁₀)alkylene (C₆-C₁₀)arylene (C₁-C₁₀)alkyl;
each of R₆ and R₇ is independently selected from the group consisting of hydrogen, methyl, ethyl, linear or branched (C₃-C₉)alkyl and fluorinated or perfluorinated (C₁-C₉)alkyl; and
with the proviso that when only one of the first repeating unit is present in the polymer wherein one of R₁, R₂, R₃ and R₄ is —CN and each of R₆ and R₇ is hydrogen, then Z is not O.

16. The polymer according to claim 15, wherein:
m is 0 or 1;
at least one of R₁, R₂, R₃ and R₄ is —CN;
the remaining R₁, R₂, R₃ and R₄ is independently selected from the group consisting of hydrogen, methyl, ethyl, linear or branched (C₃-C₆)alkyl and phenyl(C₁-C₃)alkyl;
Z is O or NR₈, where R₈ is methyl, ethyl, n-propyl, iso-propyl, n-butyl, iso-butyl, cyclopentyl, cyclohexyl, cycloheptyl, phenyl, benzyl and phenethyl; and
R₆ and R₇ independently of each other selected from the group consisting of hydrogen and methyl.

17. The polymer according to claim 15, which is selected from the group consisting of:
a copolymer of bicyclo[2.2.1]hept-5-ene-2-carbonitrile (NBCN) and N-phenyl maleimide (N-PhMI);
a copolymer of bicyclo[2.2.1]hept-5-ene-2-carbonitrile (NBCN) and 2-methyl-maleic anhydride;
a copolymer of bicyclo[2.2.1]hept-5-ene-2-carbonitrile (NBCN) and N-cyclohexyl maleimide; and
a copolymer of bicyclo[2.2.1]hept-5-ene-2-carbonitrile (NBCN) and N-methyl maleimide.

18. A polymer comprising:
a) one or more distinct first repeating unit represented by formula (IA), each of said first repeating unit is derived from a monomer of formula (I): 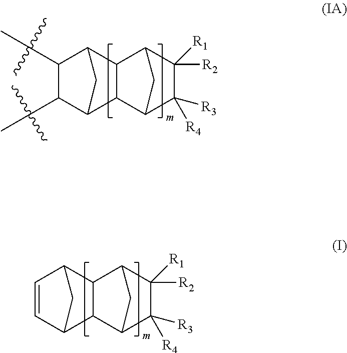
wherein: [symbol]
represents a position at which the bonding takes place with another repeat unit;
m is an integer 0, 1 or 2;
at least one of R₁, R₂, R₃ and R₄ is —CN or —R₅CN, where R₅ is selected from the group consisting of (C₁-C₁₀)alkylene, (C₃-C₈) cycloalkylene, (C₁-C₁₀)alkylene (C₃-C₈) cycloalkylene, (C₁-C₁₀)alkylene (C₃-C₈) cycloalkylene (C₁-C₁₀)alkylene, (C₁-C₁₀)alkylene (C₆-C₁₀)arylene and (C₁-C₁₀)alkylene (C₆-C₁₀)arylene (C₁-C₁₀)alkylene;
the remaining R₁, R₂, R₃ and R₄ are the same or different and independently of each other selected from the group consisting of hydrogen, methyl, ethyl, linear or branched (C₁-C₁₀)alkyl, (C₃-C₈) cycloalkyl, (C₁-C₁₀)alkyl(C₃-C₈) cycloalkyl and (C₁-C₁₀)alkyl(C₆-C₁₀)aryl;
b) one or more distinct second repeating unit represented by formula (IIA), each of said second repeating unit is derived from a monomer of formula (II): 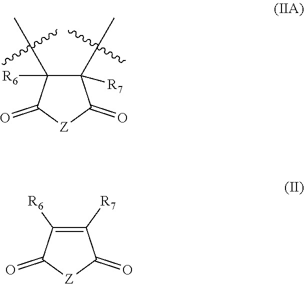
wherein: [symbol]
represents a position at which the bonding takes place with another repeat unit;
Z is O or NR₈, where R₈ is selected from the group consisting of hydrogen, (C₁-C₁₀)alkyl, (C₃-C₈) cycloalkyl, (C₁-C₁₀)alkylene (C₃-C₈) cycloalkyl, (C₁-C₁₀)alkylene (C₃-C₈) cycloalkylene (C₁-C₁₀)alkyl, (C₆-C₁₀)aryl, (C₁-C₁₀)alkylene (C₆-C₁₀)aryl and (C₁-C₁₀)alkylene (C₆-C₁₀)arylene (C₁-C₁₀)alkyl;
each of R₆ and R₇ is independently selected from the group consisting of hydrogen, methyl, ethyl, linear or branched (C₃-C₉)alkyl and fluorinated or perfluorinated (C₁-C₉)alkyl; and
c) one or more distinct third repeat unit of formula (IIIA) derived from a monomer of formula (III): 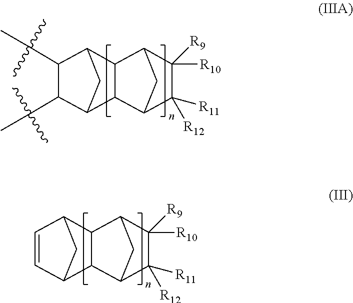
wherein: [symbol]
represents a position at which the bonding takes place with another repeat unit;
n is an integer 0, 1 or 2;
each of R₉, R₁₀, R₁₁ and R₁₂ is independently selected from the group consisting of hydrogen, linear or branched (C₁-C₁₆)alkyl, hydroxy (C₁-C₁₂)alkyl, perfluoro (C₁-C₁₂)alkyl, (C₃-C₁₂) cycloalkyl, (C₆-C₁₂)bicycloalkyl, (C₇-C₁₄)tricycloalkyl, (C₆-C₁₀)aryl, (C₆-C₁₀)aryl(C₁-C₃)alkyl, perfluoro (C₆-C₁₀)aryl, perfluoro (C₆-C₁₀)aryl(C₁-C₃)alkyl, (C₅-C₁₀) heteroaryl, (C₅-C₁₀) heteroaryl(C₁-C₃)alkyl, hydroxy, (C₁-C₁₂)alkoxy, (C₃-C₁₂)cycloalkoxy, (C₆-C₁₂)bicycloalkoxy, (C₇-C₁₄)tricycloalkoxy, —(CH₂)ₐ—(O—(CH₂)_{b})_{c}—O—(C₁-C₄)alkyl, where a, b and c are integers from 1 to 4, (C₆-C₁₀)aryloxy (C₁-C₃)alkyl, (C₅-C₁₀)heteroaryloxy (C₁-C₃)alkyl, (C₆-C₁₀)aryloxy, (C₅-C₁₀)heteroaryloxy, (C₁-C₆)acyloxy and halogen.

19. The polymer according to claim 18, wherein the polymer contains one distinct repeat unit of formula (IA), one distinct repeat unit of formula (IIA) and one distinct repeat unit of formula (IIIA) and wherein said repeat unit of formula (IA) is present at a mole percent of about 10 to 20, said repeat unit of formula (IIIA) is present at a mole percent of about 30 to 40 provided that total mole percent of repeat units of formulae (IA) and (IIIA) is about 50 and said repeat unit of formula (IIA) is present at a mole percent of about 50.

20. The polymer according to claim 18, which is selected from the group consisting of:
a terpolymer of bicyclo[2.2.1]hept-5-ene-2-carbonitrile (NBCN), norbornene (NB) and maleic anhydride;
a terpolymer of bicyclo[2.2.1]hept-5-ene-2-carbonitrile (NBCN), 5-butylbicyclo[2.2.1]hept-2-ene (5-butylnorbornene, BuNB) and maleic anhydride;
a terpolymer of bicyclo[2.2.1]hept-5-ene-2-carbonitrile (NBCN), 5-((2-(2-methoxyethoxy) ethoxy)methyl)bicyclo[2.2.1]hept-2-ene (NBTON) and maleic anhydride;
a terpolymer of bicyclo[2.2.1]hept-5-ene-2-carbonitrile (NBCN), 5-butylbicyclo[2.2.1]hept-2-ene (5-butylnorbornene, BuNB) and N-phenyl maleimide (N-PhMI); and
a terpolymer of bicyclo[2.2.1]hept-5-ene-2-carbonitrile (NBCN), 5-((2-(2-methoxyethoxy) ethoxy)methyl)bicyclo[2.2.1]hept-2-ene (NBTON) and N-phenyl maleimide (N-PhMI).
